(19) United States
(12) Patent Application Publication
(10) Pub. No.: US 2022/0381920 A1
(43) Pub. Date: Dec. 1, 2022

(54) Obstacle Detection System

(71) Applicant: Yanmar Power Technology Co., Ltd., Osaka (JP)

(72) Inventor: Tomohisa Kano, Osaka (JP)

(73) Assignee: Yanmar Power Technology Co., Ltd., Osaka (JP)

(21) Appl. No.: 17/769,754

(22) PCT Filed: Oct. 6, 2020
(86) PCT No.: PCT/JP2020/037861

§ 371 Date: Apr. 17, 2022

(30) Foreign Application Priority Data
Oct. 18, 2019 (JP) 2019-191148

(51) Int. Cl. G01S 17/931; G01S 7/51; G05D 1/02; A01B 69/04

(52) U.S. Cl. CPC G01S 17/931; G01S 7/51; G05D 1/0214; A01B 69/008; G05D 2201/0201

(57) ABSTRACT

In this obstacle detection system, if an obstacle has been detected by a front obstacle sensor or a rear obstacle sensor which has an obstacle detection range corresponding to the travel direction of the work vehicle, then a control unit displays the detected position of the obstacle on a display unit and performs collision avoidance control corresponding to the detection position of the obstacle; further, if an obstacle has been detected by a front obstacle sensor or a rear obstacle sensor which has an obstacle detection range not corresponding to the travel direction of the work vehicle, then the control unit displays the detected position of the obstacle on the display unit without performing collision avoidance control corresponding to the detection position of the obstacle.

### TECHNICAL FIELD

The present invention relates to an obstacle detection system for work vehicles, such as tractors, passenger mowers, or the like.

### BACKGROUND ART

The obstacle detection system described above includes, for example, a front obstacle sensor (front LIDAR sensor) that uses a laser beam to measure in three dimensions a distance to a measurement target on a front side of a work vehicle, a rear obstacle sensor (rear LIDAR sensor) that uses a laser beam to measure in three dimensions a distance to a measurement target on a rear side of the work vehicle, an obstacle detection unit that detects an obstacle, based on measurement information of the front and rear obstacle sensors, a collision avoidance control unit that performs collision avoidance control in which a collision of the work vehicle with the obstacle detected by the obstacle detection unit is avoided, and the like. In the obstacle detection system, based on switching of travel of the work vehicle from forward travel to backward travel, in a case where the work vehicle travels forward, measurement by the front obstacle sensor is performed and the obstacle detection unit is switched to a forward travel detection state where the obstacle is detected based on measurement information of the front obstacle sensor, whereas in a case where the work vehicle is traveling backward, measurement by the rear obstacle sensor is performed and the obstacle detection unit is switched to a backward travel detection state where the obstacle is detected based on measurement information of the rear obstacle sensor (see, for example, Patent Literature 1).

### CITATION LIST

### Patent Literature

Patent Literature 1: Japanese Unexamined Patent Publication No. 2019-168888

### DISCLOSURE OF INVENTION

### Problems to be Solved by the Invention

That is, in a technology described in Patent Literature 1, in a case where a travel direction of the work vehicle is a forward travel direction, obstacle detection based on the measurement information of the rear obstacle sensor whose opposite direction (backward travel direction) is set as an obstacle detection range is stopped, and in a case where the travel direction of the work vehicle is a backward travel direction, obstacle detection based on the measurement information of the front obstacle sensor whose opposite direction (forward travel direction) is set as an obstacle detection range is stopped. Thus, reduction in work efficiency caused by performing collision avoidance control by the collision avoidance control unit on an obstacle with which the work vehicle is not likely to collide, based on the measurement information of either one of the front and rear obstacle sensors that perform measurement in an opposite direction to the travel direction of the work vehicle, can be avoided.

On the other hand, in the technology described in Patent Literature 1, for example, even when there is an obstacle, such as a person or the like, near a rear of the work vehicle while the work vehicle is traveling in the forward travel direction, the obstacle is not detected based on the measurement information of the rear obstacle sensor and a user is not informed of the existence of the obstacle, so that the user suspects that the rear obstacle sensor may not properly function in some cases.

In view of this situation, a major problem of the present invention is to provide an obstacle detection system that can easily confirm that an obstacle sensor that does not correspond to a travel direction of a work vehicle properly functions while avoiding the above-described reduction in work efficiency in a case where an obstacle exists in a direction opposite to the travel direction of the work vehicle.

### Means for Solving the Problems

A first feature configuration of the present invention is that an obstacle detection system includes a front obstacle sensor in which a front side of a work vehicle is set as an obstacle detection range, a rear obstacle sensor in which a rear side of the work vehicle is set as the obstacle detection range, a display unit that displays a position of the obstacle detected by the front obstacle sensor and the rear obstacle sensor, and a control unit that determines a travel direction of the work vehicle and performs control related to the obstacle including display of the display unit, based on determination results and detection information of the front obstacle sensor and the rear obstacle sensor, if the obstacle has been detected by the front obstacle sensor or the rear obstacle sensor whose detection range corresponds to the travel direction of the work vehicle, the control unit displays a detection position of the obstacle on the display unit and executes collision avoidance control in accordance with the detection position of the obstacle, and if the obstacle has been detected by the front obstacle sensor or the rear obstacle sensor whose detection range does not correspond to the travel direction of the work vehicle, the control unit displays a detection position of the obstacle on the display unit without executing the collision avoidance control.

According to this configuration, if an obstacle has been detected by either one of the front and rear obstacle sensors whose obstacle detection range corresponds to the travel direction of the work vehicle, the detection position of the obstacle at that time is displayed on the display unit and collision avoidance control in accordance with the detection position of the obstacle is executed, so that it is possible to inform the user of the detection position of the obstacle and to avoid a possibility that the work vehicle collides with the obstacle existing in the travel direction of the work vehicle.

On the other hand, if an obstacle has been detected by either one of the front and rear obstacle sensor whose detection range does not correspond to the travel direction of the work vehicle, the detection position of the obstacle at that time is only displayed on the display unit, and collision avoidance control in accordance with the detection position of the obstacle is not executed, so that it is possible to inform the user of the detection position of the obstacle while avoiding controlling travel of the work vehicle or the like in accordance with the detection position of the obstacle with which the work vehicle is not likely to collide because the obstacle exists in the direction opposite to the travel direction of the work vehicle.

As a result, it is possible to provide an obstacle detection system that, in a case where there is an obstacle in the direction opposite to a travel direction of a work vehicle, allows a user to easily confirm that either one of front and rear obstacle sensors whose obstacle detection range does not correspond to the travel direction of the work vehicle properly functions while avoiding reduction in work efficiency or the like caused by executing collision avoidance control in accordance with a detection position of the obstacle that the work vehicle is not likely to collide.

### BRIEF DESCRIPTION OF DRAWINGS

FIG. 1 is a view illustrating a schematic configuration of an automatic travel system for a work vehicle.

FIG. 2 is a plan view of a tractor illustrating imaging ranges of cameras.

FIG. 3 is a side view of the tractor illustrating measurement ranges of obstacle sensors and the like.

FIG. 4 is a plan view of a tractor illustrating measurement ranges of obstacle sensors.

FIG. 5 is a plan view illustrating an example of a target path for automatic travel.

FIG. 6 is a block diagram illustrating a schematic configuration of an automatic travel system for a work vehicle.

FIG. 7 is a block diagram illustrating a schematic configuration of an obstacle detection system and the like.

FIG. 8 is a view illustrating an obstacle detection range and an obstacle non-detection range in a distance image of a front obstacle sensor.

FIG. 9 is a view illustrating an obstacle detection range and an obstacle non-detection range in a work device lowered state in a distance image of a rear obstacle sensor.

FIG. 10 is a view illustrating an obstacle detection range and an obstacle non-detection range in a work device lifted state in a distance image of the rear obstacle sensor.

FIG. 11 is a view illustrating a display state of a display unit when no obstacle is detected by the obstacle sensors.

FIG. 12 is a view illustrating a display state of the display unit when an obstacle is detected in a deceleration control range of a first detection range by the front obstacle sensor.

FIG. 13 is a view illustrating a display state of the display unit when an obstacle is detected in a stop control range of the first detection range by the front obstacle sensor.

FIG. 14 is a view illustrating a display state of the display unit when an obstacle is detected in a third detection range by a horizontal obstacle sensor.

FIG. 15 is a view illustrating a display state of the display unit when there is adhesion of dirt on a sensor surface of the front obstacle sensor of the rear obstacle sensor.

FIG. 16 is a view illustrating a display state of the display unit when the first detection range of the front obstacle sensor is set to an obstacle detection inhibition range.

FIG. 17 is a view illustrating a display state of the display unit when detection information of the obstacle sensors cannot be received.

FIG. 18 is a flowchart illustrating a control operation of an automatic travel control unit in obstacle display control.

FIG. 19 is a flowchart illustrating the control operation of the automatic travel control unit in obstacle display control.

FIG. 20 is a flowchart illustrating a control operation of the automatic travel control unit in collision avoidance control.

FIG. 21 is a flowchart illustrating a control operation of the automatic travel control unit in first collision avoidance processing of collision avoidance control.

FIG. 22 is a flowchart illustrating a control operation of the automatic travel control unit in second collision avoidance processing of collision avoidance control.

FIG. 23 is a flowchart illustrating a control operation of the automatic travel control unit in dirt handling travel control.

FIG. 24 is a flowchart illustrating a control operation of the automatic travel control unit in detection status display control.

### DESCRIPTION OF EMBODIMENTS

As an example of a mode for carrying out the present invention, an embodiment in which an obstacle detection system according to the present invention is applied to a tractor that is an example of a work vehicle will be described below with reference to the accompanying drawings.

The obstacle detection system of the present invention can be applied to, in addition to tractors, passenger work vehicles capable of automatic travel, such as, for example, passenger management machines, passenger mowers, passenger rice transplanters, combines, snow plows, wheel loaders, transport vehicles, or the like, and unmanned work vehicles, such as unmanned tilling devices and unmanned mowers.

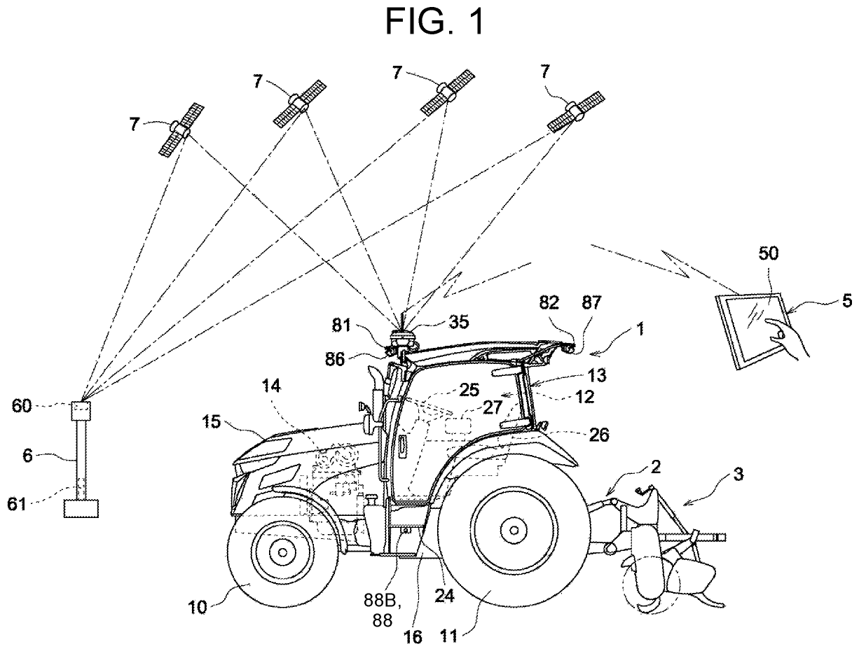

As illustrated in FIGS. 1 to 4, a rotary tilling device 3 that is an example of a work device is connected to a tractor 1 illustrated as an example in this embodiment via a linkage mechanism 2 provided at a rear portion of the tractor 1 so as to move up and down and roll. Thus, the tractor 1 is configured with a rotary tilling specification that enables a tilling work by the rotary tilling device 3.

The work device connected to the rear portion of the tractor 1 may be, for example, a plow, a disk harrow, a tilling device, a subsoiler, a sowing device, a spraying device, a mowing device, a harvesting device, or the like, in addition to the rotary tilling device 3.

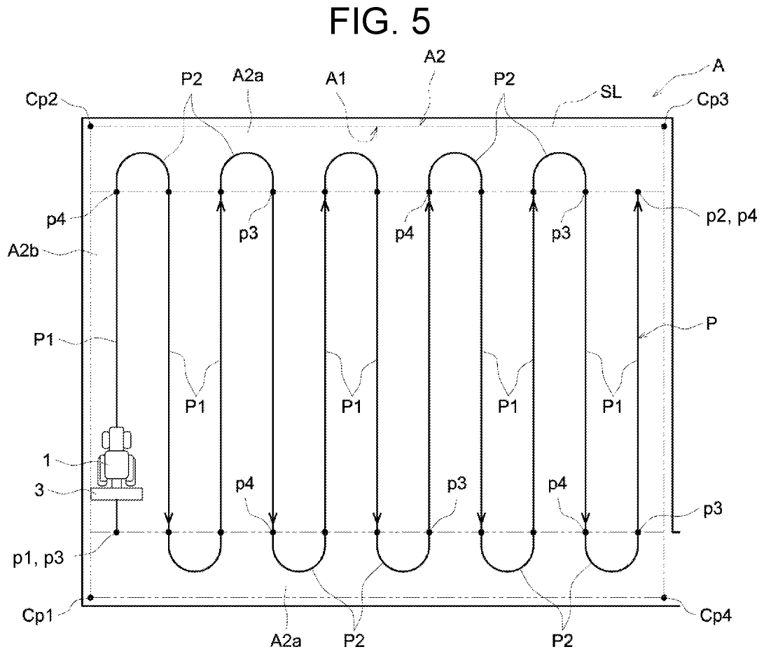

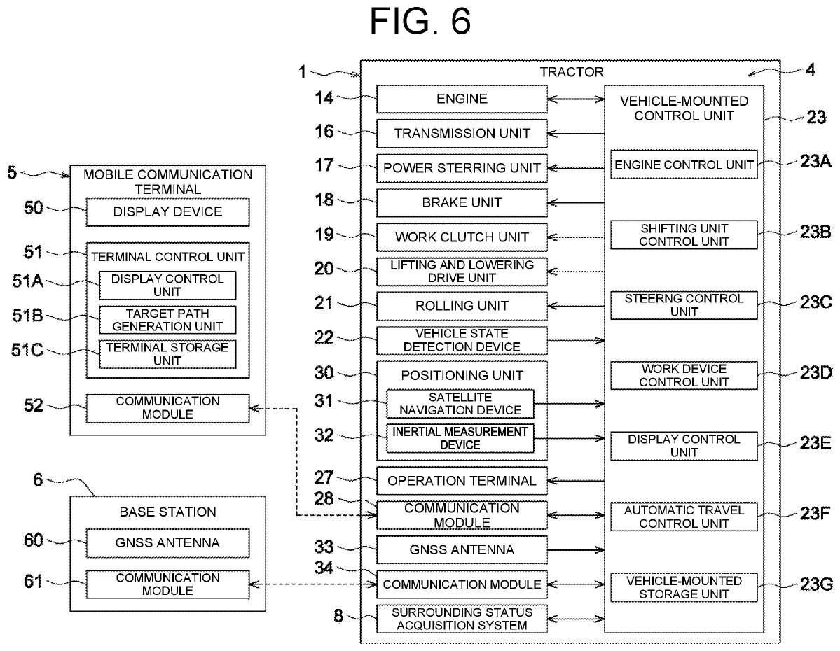

The tractor 1 can be caused to automatically travel in a field A that is an example of a work site illustrated in FIG. 5 by using an automatic travel system for a work vehicle. As illustrated in FIGS. 1 and 6, the automatic travel system for a work vehicle includes an automatic travel unit 4 mounted on the tractor 1, a mobile communication terminal 5 that is an example of a wireless communication device set up for communication so as to be wirelessly communicable with the automatic travel unit 4, and the like. The mobile communication terminal 5 includes a multi-touch display device (an example of a display unit) 50 that enables display of various types of information and input operations related to automatic travel and the like.

A tablet-type personal computer, a smartphone, or the like can be employed as the mobile communication terminal 5. Furthermore, for the wireless communication, a wireless LAN (Local Area Network), such as Wi-Fi (registered trademark) or the like, a short-range wireless communication, such as Bluetooth (registered trademark) or the like, or the like can be employed.

As illustrated in FIGS. 1 to 3 and FIG. 6, the tractor 1 includes drivable and steerable left and right front wheels 10, drivable left and right rear wheels 11, a cabin 13 forming a boarding-type drive unit 12, an electronic control type diesel engine (which will be hereinafter referred to as an engine) 14 including a common rail system, a hood 15 covering the engine 14 or the like, a shifting unit 16 for shifting power from the engine 14, and the like. An electronic control type gasoline engine having an electronic governor or the like may be employed as the engine 14.

As illustrated in FIG. 6, the tractor 1 includes a fully hydraulic power steering unit 17 that steers the left and right front wheels 10, a brake unit 18 that brakes the left and right rear wheels 11, an electronic hydraulic control type work clutch unit 19 that disconnects transmission to the rotary tilling device 3, an electronic hydraulic control type lifting and lowering drive unit 20 that lifts and lowers the rotary tilling device 3, an electronic hydraulic control type rolling unit 21 that enables driving the rotary tilling device 3 in a roll direction, an electronic hydraulic control type vehicle state detection device 22 including various sensors, switches, or the like that detect various setting states and operation states of various components of the tractor 1, an vehicle-mounted control unit 23 including various control units, and the like. As the power steering unit 17, an electric power steering unit including an electric motor for steering may be used.

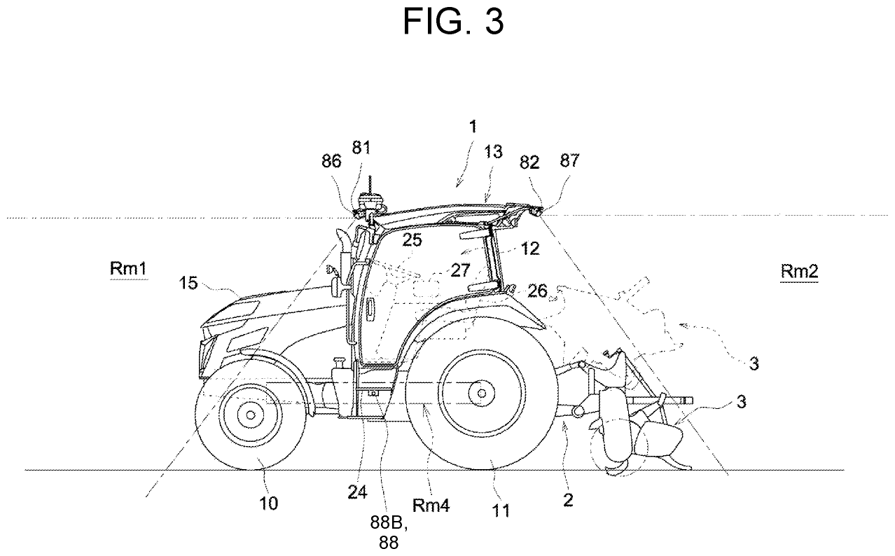

As illustrated in FIGS. 1 and 3, the drive unit 12 is provided with a steering wheel 25 for manual steering, a seat 26 for a passenger, and an operation terminal 27 that enables display of various types of information and input operations or the like. Although not illustrated, the drive unit 12 includes operation levers, such as an accelerator lever, a gear shift lever, or the like, and operation pedals, such as an accelerator pedal, a clutch pedal, or the like, or the like. A multi-touch type liquid crystal monitor, a virtual terminal compatible with ISOBUS, or the like can be employed as the operation terminal 27.

Although not illustrated, the shifting unit 16 includes an electronic control type continuously variable transmission that shifts the power from the engine 14 and an electronic hydraulic control type forward and backward switching device that switches the power between power for use in forward travel and power for use in backward travel after being shifted by the continuously variable transmission. An integrated hydro-static mechanical transmission (I-HMT) that is an example of a hydraulic mechanical continuously variable transmission that has a higher transmission efficiency than that of a hydro-static transmission (HST) is employed. The forward and backward switching device includes a hydraulic clutch for disconnecting forward travel power, a hydraulic clutch for disconnecting backward travel power, and an electromagnetic valve that controls a flow of oil to the clutches.

Instead of the I-HMT, a hydraulic mechanical transmission (HMT) that is an example of the hydraulic mechanical continuously variable transmission, the hydro-static continuously variable transmission, a belt-type continuously variable transmission, or the like may be employed as the continuously variable transmission. Alternatively, the shifting unit 16 may include, instead of the continuously variable transmission, an electronic hydraulic control type stepped transmission including a plurality of hydraulic clutches for transmission and a plurality of electromagnetic valves that control a flow of oil to the clutches.

Although not illustrated, the brake unit 18 includes left and right brakes that individually brake the left and right rear wheels 11, a foot brake system that actuates the left and right brakes in an interlocking manner with stepping operations on the left and right brake pedals provided in the drive unit 12, a parking brake system that actuates the left and right brakes in an interlocking manner with an operation of a parking lever provided in the drive unit 12, and a turning brake system that actuates the brake on an inner side of a turn in an interlocking manner with steering of the left and right front wheels 10 at a set angle or more.

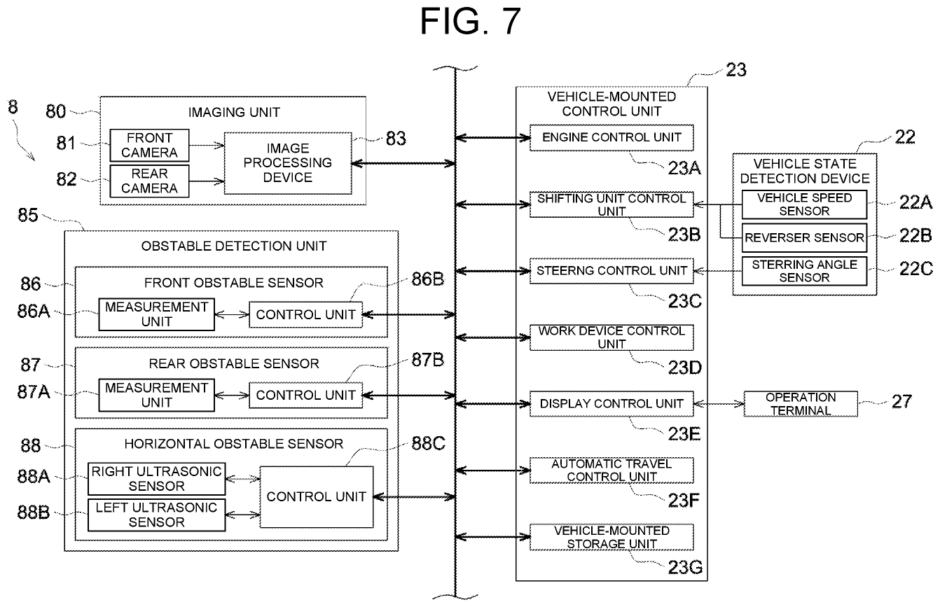

The vehicle state detection device 22 is a general term for various types of sensors and switches provided in portions of the tractor 1. As illustrated in FIG. 7, the vehicle state detection device 22 includes a vehicle speed sensor 22A that detects vehicle speed of the tractor 1, a reverser sensor 22B that detects an operation position of a reverser lever for forward travel and backward travel switching, and a steering angle sensor 22C that detects steering angles of the front wheels 10. Although not illustrated, the vehicle state detection device 22 includes a rotation sensor that detects an output rotation speed of the engine 14, an accelerator sensor that detects an operation position of the accelerator lever, and a shift sensor that detects an operation position of the gear shift lever.

As illustrated in FIGS. 6 to 7, the vehicle-mounted control unit 23 includes an engine control unit 23A that performs control related to the engine 14, a shifting unit control unit 23B that performs control related to the shifting unit 16, such as vehicle speed, forward travel and backward travel switching, or the like of the tractor 1, a steering control unit 23C that performs control related to steering, a work device control unit 23D that performs control related to the work device, such as the rotary tilling device 3 or the like, a display control unit 23E that performs control related to display and notification to the operation terminal 27 or the like, an automatic travel control unit 23F that performs control related to automatic travel, a nonvolatile vehicle-mounted storage unit 23G that stores a target path P (see FIG. 5) for automatic travel generated in accordance with the field A or the like, and the like. Each of the control units 23A to 23F is constructed by an electronic control unit in which a microcontroller and the like are integrated, various types of control programs, or the like. The control units 23A to 23F are connected in a mutually communicable manner via a controller area network (CAN).

For mutual communications among the control units 23A to 23F, for example, a communication standard other than CAN or vehicle-mounted Ethernet, CAN with flexible data rate (CAN-FD), or the like that is a next generation communication standard may be also employed.

The engine control unit 23A executes engine speed maintenance control of maintaining the engine speed at engine speed in accordance with the operation position of the accelerator lever, based on detection information from the accelerator sensor and detection information from the rotation sensor, or the like.

The shifting unit control unit 23B executes vehicle speed control in which an operation of the continuously variable transmission is controlled such that the vehicle speed of the tractor 1 is changed to speed corresponding to the operation position of the gear shift lever, based on detection information from the shift sensor and detection information from the vehicle speed sensor 22A, forward travel and backward travel switching control in which a transmission state of the forward travel and backward travel switching device is controlled based on detection information from the reverser sensor 22B, or the like. The vehicle speed control includes deceleration stop processing of decelerating the continuously variable transmission to a zero-speed state to stop travel of the tractor 1 in a case where the gear shift lever is operated to a zero-speed position.

The work device control unit 23D executes work clutch control of controlling an operation of the work clutch unit 19, based on an operation of a PTO switch provided in the drive unit 12 or the like, lifting and lowering control of controlling an operation of the lifting and lowering drive unit 20, based on an operation of a lifting and lowering switch provided in the drive unit 12, a set value of a height setting dial, or the like, rolling control of controlling an operation of the rolling unit 21, based on a set value of a set value of a roll angle setting dial provided in the drive unit 12 or the like, or the like. The PTO switch, the lifting and lowering switch, the height setting dial, and the roll angle setting dial are included in the vehicle state detection device 22.

As illustrated in FIG. 6, the tractor 1 is provided with a positioning unit 30 that measures a position and an orientation of the tractor 1. The positioning unit 30 includes a satellite navigation device 31 that measures the position and the orientation of the tractor 1 by using a global navigation satellite system (GNSS) that is an example of the satellite positioning system, an inertial measurement unit (IMU) 32 that includes a three-axis gyroscope, a three-direction accelerator sensor, or the like to measure a posture, the orientation, or the like of the tractor 1, or the like. Examples of a positioning method using a GNSS include differential GNSS: relative positioning method (DGNSS), real time kinematic GNSS: interference positioning method (RTK-GNSS), and the like. In this embodiment, RTK-GNSS that is suitable for positioning of a moving body is employed. Therefore, as illustrated in FIG. 1, a base station 6 that enables positioning by RTK-GNSS is installed in a known location in periphery of the field.

As illustrated in FIG. 1 and FIG. 6, each of the tractor 1 and the base station 6 includes a corresponding one of GNSS antennas 33 and 60 that receive radio waves transmitted from positioning satellites 7 (see FIG. 1), a corresponding one of communication modules 34 and 61 that enable wireless communication of various types of information including positioning information between the tractor 1 and the base station 6, and the like. Thus, the satellite navigation device 31 of the positioning unit 30 can measure the position and the orientation of the tractor 1 with high accuracy, based on the positioning information obtained by receiving the radio waves from the positioning satellites 7 by the GNSS antenna 33 of the tractor 1 and the positioning information obtained by receiving the radio waves from the positioning satellites 7 by the GNSS antenna 60 of the base station 6. Furthermore, the positioning unit 30 includes the satellite navigation device 31 and the inertial measurement device 32 and thus can measure the position, the orientation, and posture angles (a yaw angle, a roll angle, and a pitch angle) of the tractor 1 with high accuracy.

In the tractor 1, the inertial measurement device 32 of the positioning unit 30, the GNSS antenna 33, and the communication module 34 are included in an antenna unit 35 illustrated in FIG. 1. The antenna unit 35 is disposed in a central portion of an upper portion on a front surface side of the cabin 13 in a left-right direction.

Although not illustrated in the drawings, a vehicle body position when the position of the tractor 1 is specified is set to an axle center position of the rear wheels. The vehicle body position can be obtained from the positioning information from the positioning unit 42 and the vehicle body information including a positional relationship between a mounting position of the GNSS antenna 45 on the tractor 1 and the axle center position of the rear wheels.

As illustrated in FIG. 6, the mobile communication terminal 5 includes an electronic control unit in which a microcontroller and the like are integrated, a terminal control unit 51 including various types of control programs, and the like. The terminal control unit 51 includes a display control unit 51A that performs control related to display and notification to a display device 50 or the like, a target path generation unit 51B that generates a target path P for automatic travel, a nonvolatile terminal storage unit 51C that stores the target path P or the like generated by the target path generation unit 51B, and the like. The terminal storage unit 51C stores, as various types of information used for generating the target path P, vehicle body information, such as a turning radius of the tractor 1, a working width of the work device, such as the rotary tilling device 3 or the like, and the number of work furrows, field information obtained from the positioning information described above. With a view to specifying the shape and the size of the field A, the field information includes four corner points Cp1 to Cp4 (see FIG. 5) that are shape specific points (shape specific coordinates) in the field A obtained using GNSS when the tractor 1 is caused to travel along the outer circumferential edge of the field A, a rectangular shape specific line SL (see FIG. 5) that specifies the shape and the size of the field A by connecting the corner points Cp1 to Cp4, and the like.

As illustrated in FIG. 6, the tractor 1 and the mobile communication terminal 5 include communication modules 28 and 52, respectively, that enable wireless communication of various types of information including positioning information between the vehicle-mounted control unit 23 and the terminal control unit 51, or the like. The communication module 28 of the tractor 1 functions as a converter that converts the communication information bidirectionally into CAN and Wi-Fi in a case where Wi-Fi is employed for a wireless communication with the mobile communication terminal 5. The terminal control unit 51 can obtain various types of information related to the tractor 1 including the position, the orientation, or the like, of the tractor 1 via a wireless communication with the vehicle-mounted control unit 23. Thus, various types of information including the position, the orientation, or the like, of the tractor 1 relative to the target path P can be displayed on the display device 50 of the mobile communication terminal 5.

The target path generation unit 51B generates the target path P, based on the turning radius of the tractor 1 and the working width or the number of working furrows of the work device included in the vehicle body information, and the shape and the size of the field A included in the field information, and the like.

For example, as illustrated in FIG. 5, in a case where a start position p1 and an end position p2 of automatic travel are set in the field A having a rectangular shape and a working travel direction of the tractor 1 is set to a direction along a short side of the field A, the target path generation unit 51B first divides the field A into a margin area A1 adjacent to the outer circumferential edge of the field A and a workable area A2 located inside the margin area A1, based on the four corner points Cp1 to Cp4 and the rectangular shape specific line SL.

Next, the target path generation unit 51B divides the workable area A2 into a pair of edge areas A2a set in edge portions of long sides in the workable area A2, and a center side area A2b set between the pair of edge areas A2a, based on the turning radius of the tractor 1, the work width of the work device or the number of work rows, or the like. Thereafter, the target path generation unit 51B generates a plurality of parallel paths P1 arranged in parallel at predetermined intervals in accordance with the work width or the number of furrows in a direction along the long side of the field A in the center side area A2b. In addition, the target path generation unit 51B generates a plurality of connection paths P2 that connect the plurality of parallel paths P1 in an order in which the tractor 1 travels in each of the edge areas A2a.

Thus, the target path generation unit 51B can generate the target path P in which the tractor 1 can be caused to automatically travel from the start position p1 to the end position p2 of automatic travel that are set in the field A illustrated in FIG. 5.

In the field A illustrated in FIG. 5, the margin area A1 is an area secured between the outer circumferential edge of the field A and the workable area A2 in order to prevent the work device or the like from contacting some other object, such as a ridge, a fence, or the like adjacent to the field A when the tractor 1 automatically travels in the edge portion of the workable area A2. Each of the edge areas A2a is a direction change area when the tractor 1 moves changing the travel direction from the parallel path P1 on which the tractor 1 is currently traveling to a next parallel path P1 by following a corresponding one of the connection paths P2. The center side area A2b is a work area in which the tractor 1 automatically travels in a work state in accordance with each of the parallel paths P1.

In the target path P illustrated in FIG. 5, each of the parallel paths P1 is a work path on which the tractor 1 automatically travels while performing a work by the work device, such as the rotary tilling device 3 or the like. Each of the connection paths P2 is a non-work path on which the tractor 1 automatically travels without performing any work by the work device. A start end position p3 of each of the parallel paths P1 is a work start position in which the tractor 1 starts a work by the work device. A terminal end position p4 of each of the parallel paths P1 is a work stop position in which the tractor 1 stops a work by the work device. Among the start end positions p3 of the parallel paths P1, the start end position p3 of the parallel path P1 that is set as a first parallel path in the travel order of the tractor 1 is the start position p 1 of the automatic travel. Furthermore, the start end positions p3 of remaining ones of the parallel paths P1 are the connection positions with terminal end positions of the connection paths P2. Furthermore, the terminal end position p4 of the parallel path P1 that is set as a last parallel path in the travel order of the tractor 1 is the end position p2 of the automatic travel. Furthermore, the terminal end positions p4 of remaining ones of the parallel paths P1 are the connection positions with the start end positions of the connection paths P2.

Each of connection paths P2 includes a direction change path on which the travel direction is changed from the parallel path P1 on which the tractor 1 is currently traveling to a next parallel path P1. The direction change path can be a U-shaped turning path on which the tractor 1 travels changing the travel direction in a U-shape, a switchback turning path on which the tractor 1 travels changing the travel direction in a fishtail shape using switchback, depending on a relationship between the turning radius of the tractor 1 and the work width of the work device, such as the rotary tilling device 3 or the like, the number of work furrows, or the like.

The target path P illustrated in FIG. 5 is merely an example, and the target path generation unit 51B can generate, based on the vehicle body information that differs depending on the model of the tractor 1, the type of the work device, or the like and the field information, such as the shape and the size of the field A, that differs depending on the field A, or the like, various target paths P suitable thereto.

The target path P is stored in the terminal storage unit 51C in association with the vehicle body information, the field information, or the like, and can be displayed on the display device 50 of the mobile communication terminal 5. The target path P includes various types of information related to automatic travel, such as the travel direction (the forward travel direction or the backward travel direction) of the tractor 1, target vehicle speed, a front wheel steering angle, or the like, set in each of the parallel paths P1, each of the connection paths P2, or the like.

The terminal control unit 51 transmits the field information, the target path P, or the like stored in the terminal storage unit 51C to the vehicle-mounted control unit 23 in response to a transmission request command from the vehicle-mounted control unit 23. The vehicle-mounted control unit 23 stores the field information, the target path P, or the like that has been received in the vehicle-mounted storage unit 23G. Regarding transmission of the target path P, for example, the terminal control unit 51 may be configured to transmit all target paths P from the terminal storage unit 51C to the vehicle-mounted control unit 23 at once at a stage before the tractor 1 starts automatic travel. Furthermore, the terminal control unit 51 may be configured to divide the target path P into a plurality of divided path information for each predetermined distance to sequentially transmit a predetermined number of divided path information in accordance with the travel order of the tractor 1 from the terminal storage unit 51C to the vehicle-mounted control unit 23 each time the travel distance of the tractor 1 reaches the predetermined distance from the stage before the tractor 1 starts the automatic travel.

Detection information from various types of sensors and switches included in the vehicle state detection device 22 is input to the automatic travel control unit 23F via the shifting unit control unit 23B, the steering control unit 23C, or the like. Thus, the automatic travel control unit 23F can monitor various types of setting states, operation states of components, or the like of the tractor 1.

The automatic travel control unit 23F starts automatic travel control in which the tractor 1 is caused to automatically travel following the target path P while obtaining the position and the orientation of the tractor 1 by the positioning unit 30, in a case where various types of manual setting operations are performed to enable automatic travel of the tractor 1 by a user, such a passenger, an administrator, or the like, the display device 50 of the mobile communication terminal 5 is operated in a state where a travel mode of the tractor 1 is switched from a manual travel mode to an automatic travel mode, and a start of automatic travel is instructed.

During execution of the automatic travel control, for example, in a case where the user operates the display device 50 of the mobile communication terminal 5 to give an instruction for terminating the automatic travel or in a case where the user aboard the drive unit 12 operates a manual operation tool, such as the steering wheel 25, an acceleration pedal, or the like, the automatic travel control unit 23F terminates the automatic travel control and switches the travel mode from the automatic travel mode to the manual travel mode.

The automatic travel control by the automatic travel control unit 23F includes engine automatic control processing in which a control command for automatic travel related to the engine 14 is transmitted to the engine control unit 23A, vehicle speed automatic control processing in which a control command for automatic travel related to the vehicle speed and forward travel and backward travel switching of the tractor 1 is transmitted to the shifting unit control unit 23B, steering automatic control processing in which a control command for automatic travel related to steering is transmitted to the steering control unit 23C, work automatic control processing in which a control command for automatic travel related to the work device, such as the rotary tilling device 3 or the like, is transmitted to the work device control unit 23D, and the like.

In the engine automatic control processing, the automatic travel control unit 23F transmits an engine speed change command for instructing change of the engine speed, based on a set engine speed or the like included in the target path P, or the like to the engine control unit 23A. The engine control unit 23A executes engine speed change control for automatically changing the engine speed in response to various types of control commands related to the engine 14 transmitted from the automatic travel control unit 23F.

In the vehicle speed automatic control processing, the automatic travel control unit 23F transmits, to the shifting unit control unit 23B, a shifting operation command for instructing a shifting operation of the continuously variable transmission, based on the target vehicle speed included in the target path P, a forward travel and backward travel switching command for instructing a forward travel and backward travel switching operation of the forward travel and backward travel switching device, based on the travel direction of the tractor 1 or the like included in the target path P, or the like. The shifting unit control unit 23B executes, in response to various types of control commands related to the continuously variable transmission, the forward travel and backward travel switching device, or the like transmitted from the automatic travel control unit 23F, the automatic vehicle speed control in which the operation of the continuously variable transmission is automatically controlled, automatic forward travel and backward travel switching control in which the operation of the forward travel and backward travel switching device is automatically controlled, or the like. The automatic vehicle speed control includes automatic deceleration stop processing in which, for example, in a case where the target vehicle speed included in the target path P is zero-speed, deceleration control is executed to bring the continuously variable transmission into the zero-speed state and thus stop travel of the tractor 1, or the like.

In the steering automatic control processing, the automatic travel control unit 23F transmits a steering command for instructing steering the left and right front wheels 10, based on the front wheel steering angle or the like included in the target path P, or the like, to the steering control unit 23C. The steering control unit 23C executes automatic steering control in which an operation of the power steering unit 17 is controlled to steer the left and right front wheels 10 in response to a steering command transmitted from the automatic travel control unit 23F, automatic braking and turning control in which the brake unit 18 is operated to operate a brake in an inner side of a turn in a case where the left and right front wheels 10 are steered at a set angle or more, or the like.

In the work automatic control processing, the automatic travel control unit 23F transmits a work start command for instructing switching to a work state of the work device, such as the rotary tilling device 3, based on arrival of the tractor 1 at each work start position included in the target path P (the start end position p3 of each parallel path P1), a work stop command for instructing switching to a non-work state of the work device, based on arrival of the tractor 1 at each work stop position (the terminal end position p4 of each parallel path P1) included in the target path P, or the like to the work device control unit 23D. The work device control unit 23D controls an operation of the lifting and lowering drive unit 20 or the like in response to various types of control commands related to the work device transmitted from the automatic travel control unit 23F to execute automatic work start control in which the work device is lowered to a work height to operate, automatic work stop control in which the work device is lifted to a non-work height to be in a stand by state, or the like.

That is, the above-described automatic travel unit 4 includes the power steering unit 17, the brake unit 18, the work clutch unit 19, the lifting and lowering drive unit 20, the rolling unit 21, the vehicle state detection device 22, the vehicle-mounted control unit 23, the positioning unit 30, the communication modules 28 and 34, and the like. By properly operating these components, the tractor 1 can be caused to automatically travel with high accuracy following the target path P and a work by the work device, such as the rotary tilling device 3 or the like, can be properly performed.

As illustrated in FIGS. 6 to 7, the tractor 1 includes a surrounding status acquisition system 8 that acquires a surrounding status of the tractor 1. As illustrated in FIG. 7, the surrounding status acquisition system 8 includes an imaging unit 80 that captures images around the tractor 1 to acquire image information and an obstacle detection unit 85 that detects obstacles existing around the tractor 1. Obstacles detected by the obstacle detection unit 85 include a person, such as a worker working in the field A or the like, another work vehicle, a utility pole, a tree, and the like existing in the field A.

As illustrated in FIGS. 1 to 3 and FIG. 7, the imaging unit 80 includes a front camera 81 for which a first imaging range Ri1 extending forward from the cabin 13 is set as an imaging range thereof, a rear camera 82 for which a second imaging range Ri2 extending rearward from the cabin 13 is set as an imaging range thereof, and an image processing device 83 (see FIG. 7) that processes the image information from each of the front and rear cameras 81 and 82.

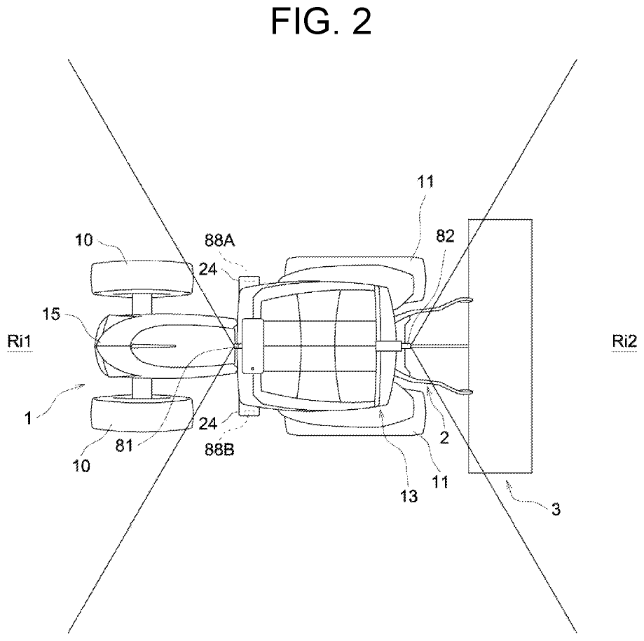

As illustrated in FIG. 2, the front camera 81 and the rear camera 82 are arranged on a center line in the left-right direction of the tractor 1. The front camera 81 is arranged in the central portion of the upper portion on a front end side of the cabin 13 in the left-right direction in a front-lowering posture to look down a front side of the tractor 1 from a diagonally upper side. Thus, for the front camera 81, a predetermined range on a front side of the vehicle body with the center line of the tractor 1 in the left-right direction as a symmetrical axis is set as the first imaging range Ri1. The rear camera 82 is arranged in the central portion of the upper portion on a rear end side of the cabin 13 in the left-right direction in a rear-down posture to look down a rear side of the tractor 1 from the diagonally upper side. Thus, for the rear camera 82, a predetermined range on a rear side of the vehicle body with the center line of the tractor 1 in the left-right direction as a symmetrical axis is set as the second imaging range Ri2.

As illustrated in FIG. 7, the image processing device 83 is constructed by an electronic control unit in which a microcontroller and the like are integrated, various types of control programs, or the like. The image processing device 83 is connected to the vehicle-mounted control unit 23 or the like in a mutually communicable manner via CAN.

The image processing device 83 performs image generation processing in which, for image information transmitted sequentially from each of the front and rear cameras 81 and 82, a front side image and a rear side image of the tractor 1 corresponding to the imaging ranges of the cameras 81 and 82 are generated, or the like. Then, image transmission processing in which each generated image is transmitted to the display control unit 23E of the vehicle-mounted control unit 23 is performed. The display control unit 23E transmits each image from the image processing device 83 to the operation terminal 27 via CAN and also to the display control unit 51A of the mobile communication terminal 5 via the communication modules 28 and 52.

Thus, a front side image and a rear side image of the tractor 1 generated by the image processing device 83 can be displayed on the operation terminal 27 of the tractor 1, the display device 50 of the mobile communication terminal 5, or the like. By this display, the user can easily grasp situations in the front and rear sides of the tractor 1.

The imaging unit 80 may include, in addition to the front camera 81, the rear camera 82, and the image processing device 83 described above, a right camera for which a third imaging range to right from the cabin 13 is set as an imaging range and a left camera for which a fourth imaging range to left from the cabin 13 is set as an imaging range. In this case, the image processing device 83 may be configured to perform image generation processing in which front, rear, left, and right images corresponding to the imaging range of each of the cameras for the image information transmitted sequentially from each of the front, rear, left and right cameras are generated, all-surrounding image generation processing in which an all-surrounding image (for example, a surround view) of the tractor 1 is generated by combining the image information from all of the cameras, or the like. Then, each of the images and the all-surrounding image generated by the image processing device 83 may be transmitted to the operation terminal 27 of the tractor 1 and the display control unit 51A of the mobile communication terminal 5 of the tractor 1 and may be displayed on the operation terminal 27 and the display device 50 of the mobile communication terminal 5.

As illustrated in FIG. 1, FIGS. 3 to 4, and FIG. 7, the obstacle detection unit 85 includes a front obstacle sensor 86 for which the front side of the tractor 1 is set as an obstacle detection range thereof, a rear obstacle sensor 87 for which the rear side of the tractor 1 is set as an obstacle detection range thereof, and a horizontal obstacle sensor 88 for which both left and right sides of the tractor 1 are set as obstacle detection ranges. LIDAR sensors that use pulse-like near-infrared laser light for detecting obstacles are employed for the front obstacle sensor 86 and the rear obstacle sensor 87. A sonar that uses ultrasonic waves for detecting obstacles is employed for the horizontal obstacle sensor 88.

As illustrated in FIGS. 1 to 4 and FIG. 7, each of the front obstacle sensor 86 and the rear obstacle sensor 87 includes a corresponding one of measurement units 86A and 87A that use near-infrared laser light to measure a distance to each distance measurement point (a measurement object) existing in a measurement range and a corresponding one of control units 86B and 87B that generate distance images, based on measurement information from the measurement units 86A and 87A. The horizontal obstacle sensor 88 includes a right ultrasonic sensor 88A and a left ultrasonic sensor 88B that transmit and receive ultrasonic waves and a single control unit 88C that measures a distance to a measurement object existing in a measurement range, based on transmission and reception of ultrasonic waves by each of the ultrasonic sensors 88A and 88B.

The control units 86B, 87B, and 88C of the obstacle sensors 86 to 88 are constructed by an electronic control unit in which a microcontroller and the like are integrated and various types of control programs. Each of the control units 86B, 87B, and 88C is connected to the vehicle-mounted control unit 23 or the like in a mutually communicable manner via CAN.

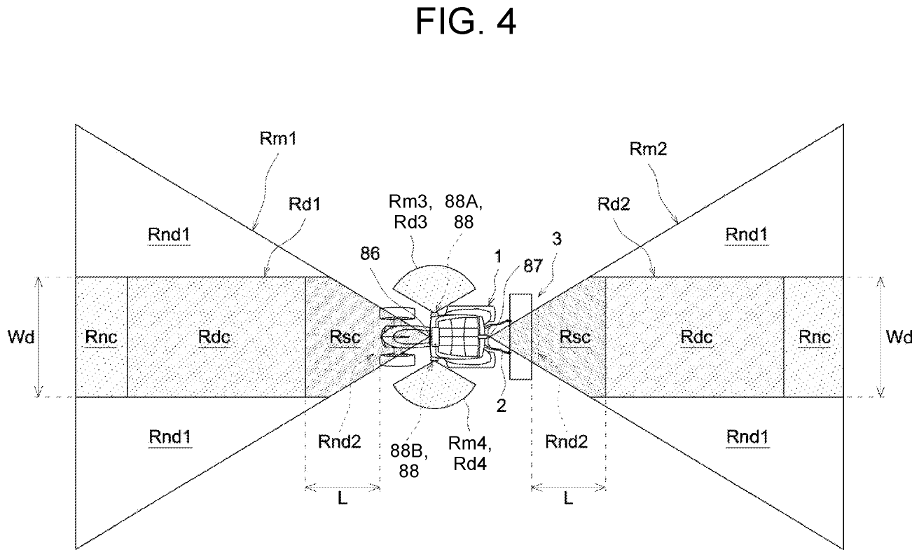

As illustrated in FIGS. 3 to 4, for the front obstacle sensor 86, the first measurement range Rm1 extending forward from the cabin 13 is set as the measurement range thereof. For the rear obstacle sensor 87, the second measurement range Rm2 extending rearward from the cabin 13 is set as the measurement range thereof. For the horizontal obstacle sensor 88, the third measurement range Rm3 extending rightward from the cabin 13 and the fourth measurement range Rm4 extending leftward from the cabin 13 are set as the measurement ranges thereof.

As illustrated in FIG. 1 and FIGS. 3 to 4, similar to the front camera 81 and the rear camera 82, the front obstacle sensor 86 and the rear obstacle sensor 87 are arranged on the center line of the tractor 1 in the left-right direction. The front obstacle sensor 86 is arranged on the central portion of the upper portion on the front end side of the cabin 13 in a left-right direction in a forward-down posture to look down the front side of the tractor 1 from the diagonally upward side. Thus, for the front obstacle sensor 86, a predetermined range on the front side of the vehicle body with the center line of the tractor 1 in the left-right direction as a symmetrical axis is set as the first measurement range Rm1 for measurement by the measurement unit 86A. The rear obstacle sensor 87 is arranged in the central portion of the upper portion on the rear end side of the cabin 13 in the left-right direction in a rear-down posture to look down the rear side of the tractor 1 from the diagonally upward side. Thus, for the rear obstacle sensor 87, a predetermined range on the rear side of the vehicle body with the center line of the tractor 1 in the left-right direction as a symmetrical axis is set as the second measurement range Rm2 for measurement by the measurement unit 87A.

As illustrated in FIG. 2, the right ultrasonic sensor 88A is mounted on a right boarding step 24 arranged between the right front wheel 10 and the right rear wheel 11 in a posture facing outward from a right side of the vehicle body. Thus, for the right ultrasonic sensor 88A, a predetermined range facing outward from the right side of the vehicle body is set as the third measurement range Rm3. As illustrated in FIGS. 1 to 3, the left ultrasonic sensor 88B is mounted on a left boarding step 24 arranged between the left front wheel 10 and the left rear wheel 11 in a posture facing outward from a left side of the vehicle body. Thus, for the left ultrasonic sensor 88B, a predetermined range facing outward from the left side of the vehicle body is set as the fourth measurement range Rm4.

As illustrated in FIGS. 3 to 4 and FIG. 7, each of the measurement units 86A and 87A of the front obstacle sensor 86 and the rear obstacle sensor 87 measures a distance from a corresponding one of the measurement units 86A and 87A to a corresponding one of measurement points in the first measurement range Rm1 and the second measurement range Rm2 by a time of flight (TOF) method in which the distance to each of the measurement points is measured based on a round time taken for irradiated near-infrared laser light to arrive at a measurement point and return. Each of the measurement units 86A and 87A scans the near-infrared laser light horizontally and vertically at high speed over the entire first measurement range Rm1 or the entire second measurement range Rm2 and sequentially measures the distance to a corresponding one of measurement points at each scanning angle (coordinate) to perform three-dimensional measurement in the first measurement range Rm1 or the second measurement range Rm2. Each of the measurement units 86A and 87A sequentially measures an intensity of reflected light (which will be hereinafter referred to as a reflection intensity) from a corresponding one of the measurement points obtained when horizontally and vertically scanning the near-infrared laser light at high speed over the entire first measurement range Rm1 or the entire second measurement range Rm2. Each of the measurement units 86A and 87A repeatedly measures the distance to the corresponding one of the measurement points in the first measurement range Rm1 and the second measurement range Rm2, the reflection intensity, or the like in real time.

The control units 86B and 87B of the front obstacle sensor 86 and the rear obstacle sensor 87 generates a distance image from measurement information, such as the distance to the corresponding one of the measurement points measured by the measurement units 86A and 87A, the scanning angle (coordinate) for the corresponding one of the measurement points, or the like, extracts a measurement point group that is presumed as an obstacle, and transmits measurement information related to the extracted measurement point group as measurement information related to an obstacle to the vehicle-mounted control unit 23.

Each of the control units 86B and 87B of the front obstacle sensor 86 and the rear obstacle sensor 87 determines whether a distance value of a corresponding one of the measurement points measured by the measurement units 86A and 87A matches an invalid condition, sets the distance value that matches the invalid condition as an invalid value, and transmits the invalid value to the vehicle-mounted control unit 23.

Specifically, each of the control units 86B and 87B uses a feature of dirt on a sensor surface that the dirt exists at a close distance from the front obstacle sensor 86 or the rear obstacle sensor 87 to set a distance value of a measurement point having the feature as an invalid value. Thus, use of the distance value related to the dirt on the sensor surface as measurement information related to an obstacle in the vehicle-mounted control unit 23 is prevented.

In addition, each of the control units 86B and 87B uses a feature of a floating object, such as dust, fog, or the like, that exists in a close distance to the front obstacle sensor 86 or the rear obstacle sensor 87 but has a very weak reflection intensity to set a distance value of a measurement point having the feature as an invalid value. Thus, use of the distance value of the measurement point related to the floating object as measurement information related to an obstacle in the vehicle-mounted control unit 23 is prevented.

As illustrated in FIGS. 3 to 4 and FIG. 7, the control unit 88C of the horizontal obstacle sensor 88 determines whether there is a measurement object in the third measurement range Rm3 or the fourth measurement range Rm4, based on transmission and reception of ultrasonic waves by the left and right ultrasonic sensors 88A and 88B. The control unit 88C measures a distance to the measurement object from each of the ultrasonic sensors 88A and 88B by a time of flight (TOF) method in which a distance to a measurement point is measured based on a round time taken for output ultrasonic waves to arrive at the measurement point and return and transmits the measured distance to the measurement object and a direction of the measurement object as measurement information related to an obstacle to the vehicle-mounted control unit 23.

As illustrated in FIG. 4 and FIGS. 8 to 10, each of the control units 86B and 87B of the front obstacle sensor 86 and the rear obstacle sensor 87 performs cutting processing and masking processing based on vehicle body information on the measurement ranges Rm1 and Rm2 of the measurement units 86A and 87A to limit the obstacle detection ranges for detection by the front obstacle sensor 86 and the rear obstacle sensor 87 to a first detection range Rd1 that is set to a forward travel side of the tractor 1 and a second detection range Rd2 that is set to a rearward travel side of the tractor 1. As illustrated in FIG. 4, in the horizontal obstacle sensor 88, the third measurement range Rm3 and the fourth measurement range Rm4 are set as a third detection range Rd3 and a fourth detection range Rd4.

In the cutting processing, each of the control units 86B and 87B of the front obstacle sensor 86 and the rear obstacle sensor 87 acquires a maximum width of the vehicle body including the work device in the left-right direction (a width of the rotary tilling device 3 in the left-right direction in this embodiment) by communication with the vehicle-mounted control unit 23 and sets an obstacle detection target width Wd by adding a predetermined safe zone to the maximum width of the vehicle body in the left-right direction. Then, in the first measurement range Rm1 and the second measurement range Rm2, a range outside the detection target width Wd is set as a first non-detection range Rnd1 by the cutting processing and is removed from each of the detection ranges Rd1 and Rd2.

In the masking processing, each of the control units 86B and 87B sets, as a second non-detection range Rnd2 by the masking processing, a range obtained by adding a predetermined safe zone to a range in which the front end side of the tractor 1 enters the first measurement range Rm1 and a range in which the rear end side of the work device enters the second measurement range Rm2 to remove the set range from each of the detection ranges Rd1 and Rd2.

By limiting the obstacle detection ranges to the first detection range Rd1 and the second detection range Rd2 in the above-described manner, increase in detection load caused by detecting an obstacle that is outside the detection target width Wd and is not likely to collide with the tractor 1 by the front obstacle sensor 86 and the rear obstacle sensor 87 and a probability that the front obstacle sensor 86 and the rear obstacle sensor 87 misdetect the front end side or the rear end side of the tractor 1 hat has entered the first measurement range Rm1 or the second measurement range Rm2 as an obstacle are avoided.

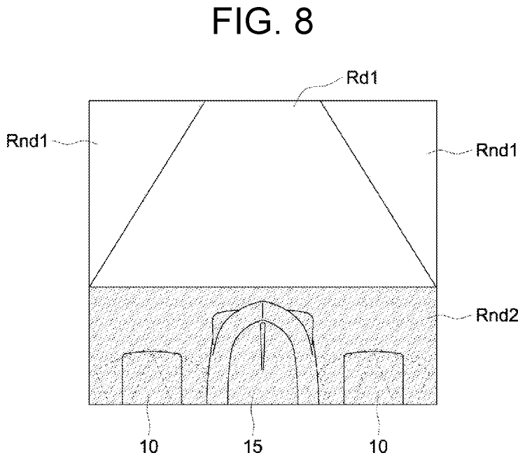

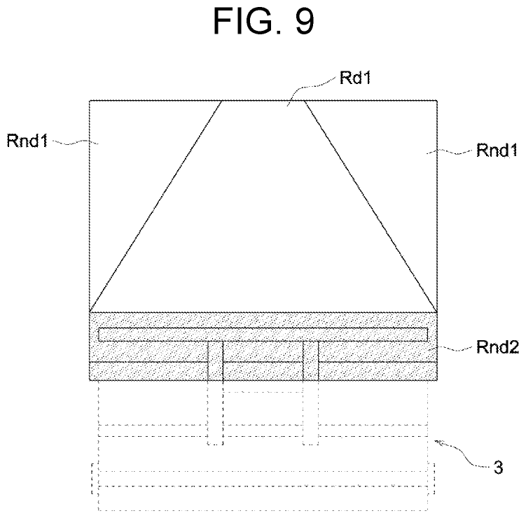

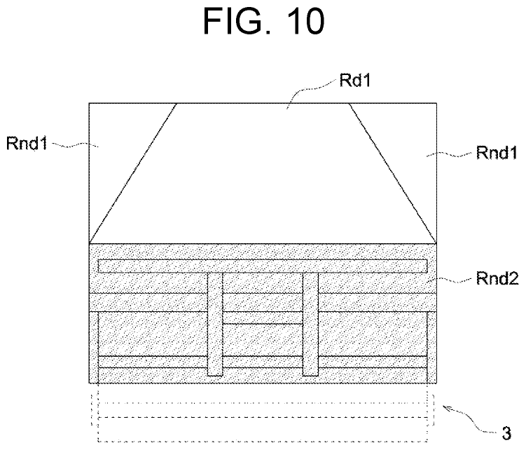

The second non-detection range Rnd2 illustrated in FIG. 8 is an example of the non-detection range suitable to the front side of the vehicle body in which the left and right front wheels 10 and the hood 15 are present. The second non-detection range Rnd2 illustrated in FIG. 9 is an example of the non-detection range suitable to the work state where the rotary tilling device 3 is lowered to the work height on the rear side of the vehicle body. The second non-detection range Rnd2 illustrated in FIG. 10 is an example of the non-detection range suitable to the non-work state where the rotary tilling device 3 is lifted to a retreat height on the rear side of the vehicle body. The second non-detection range Rnd2 on the rear side of the vehicle body is appropriately switched in an interlocking manner with lifting and lowering of the rotary tilling device 3.

Information related to the first detection range Rd1, the second detection range Rd2, the first non-detection range Rnd1, the second non-detection range Rnd2 is included in the above-described distance image and is transmitted to the vehicle-mounted control unit 23 together with the above-described distance image.

As illustrated in FIG. 4, each of the detection ranges Rd1 and Rd2 of the front obstacle sensor 86 and the rear obstacle sensor 87 is divided into a stop control range Rsc, a deceleration control range Rdc, and a notification control range Rnc, based on collision determination processing in which a collision prediction time becomes a set time (for example, 3 seconds). The stop control range Rsc is set to a range from the front obstacle sensor 86 or the rear obstacle sensor 87 to a determination reference position of the collision determination processing. The deceleration control range Rdc is set to a range from the determination reference position to a deceleration start position. The notification control range Rnc is set to a range from the deceleration start position to a measurement limit position of the front obstacle sensor 86 or the rear obstacle sensor 87. Each determination reference position is set to a position that is away from the front end or the rear end of the vehicle body including the rotary tilling device 3 by a certain separation distance L (for example, 2000 mm) in the front-rear direction of the vehicle body. For the horizontal obstacle sensor 88, the third detection range Rd3 and the fourth detection range Rd4 are set as the stop control range.

Various changes can be made to setting of the detection ranges Rd1 to Rd4 of the obstacle sensors 86 to 88 and the control ranges Rsc, Rdc, and Rnc in the first detection range Rd1 of the front obstacle sensor 86 and the second detection range Rd2 of the rear obstacle sensor 87 in accordance with a type or a model of the work vehicle, work contents, or the like. In addition, the cutting processing may not be performed on the measurement ranges Rm1 and Rm2 of the front obstacle sensor 86 and the rear obstacle sensor 87.

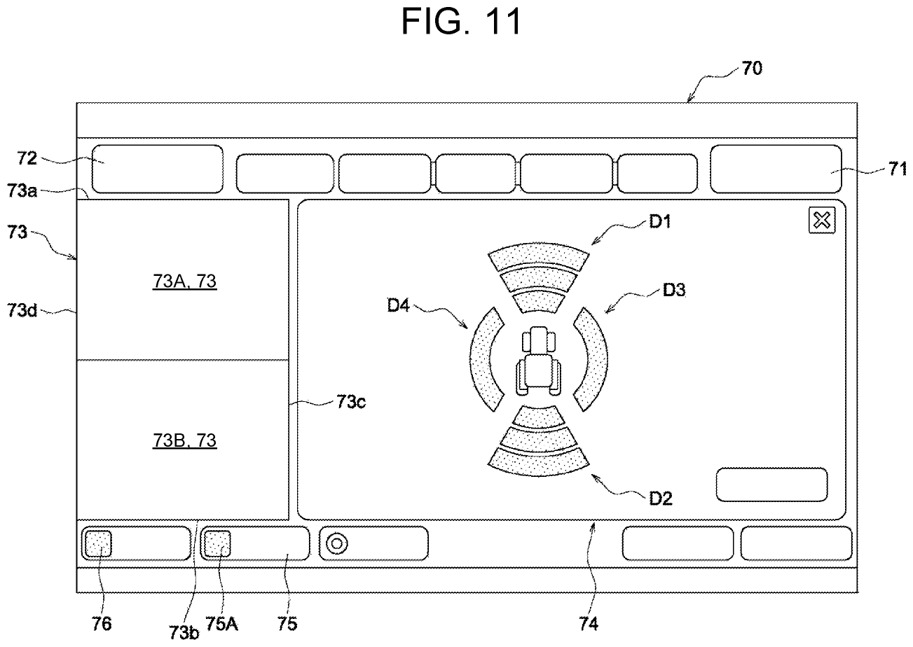

A display screen displayed on the display device 50 of the mobile communication terminal 5 includes a path generation screen for generating a target path and a work screen 70 for automatic travel illustrated in FIGS. 11 to 17. The display control unit 51A of the mobile communication terminal 5 switches the display screen of the display device 50 to the work screen 70 in a case where an operation for displaying the work screen is performed on the display device 50.

As illustrated in FIGS. 11 to 17, the work screen 70 includes a travel instruction button 71 used for instructing start or pause of automatic travel of the tractor 1, an emergency stop button 72 used for instructing emergency stop of the tractor 1 during automatic travel, an image display unit 73 on which a front side image and a rear side image of the tractor 1 from the imaging unit 80 is displayed, an information display unit 74 on which various types of information are displayed, an obstacle information display button 75 used for instructing display of detection information from an obstacle detection unit 85 on the information display unit 74, and the like.

In a case where a stop state of the tractor 1 has been detected by a communication with the vehicle-mounted control unit 23 or the like, the display control unit 51A of the mobile communication terminal 5 switches the travel instruction button 71 to a start button used for instructing start of travel of the tractor 1. If an automatic travel state of the tractor 1 has been detected, the travel instruction button 71 is switched to a pause button used for instructing pause of the tractor 1.

The display control unit 51A switches a display state of the information display unit 74, in accordance with an operation of the obstacle information display button 75, from a work information display state where a progress status of the work or the like is displayed to an obstacle information display state where a position of an obstacle detected by each of the obstacle sensors 86 to 88 of the obstacle detection unit 85 or the like is displayed. Thus, the information display unit 74 functions as an obstacle information display unit that displays the position of the obstacle detected by each of the obstacle sensors 86 to 88 or the like. In each of FIGS. 11 to 17, an obstacle information display state of the information display unit 74 in which the obstacle information display unit 74 functions as the obstacle information display unit (which will be hereinafter referred to as the obstacle information display unit 74) is illustrated as an example.

As illustrated in FIGS. 11 to 17, in the obstacle information display unit 74, a first display area D1 in which a detection state of an obstacle by the front obstacle sensor 86 is displayed, a second display area D2 in which a detection state of an obstacle by the rear obstacle sensor 87 is displayed, and a third display area D3 and a fourth display area D4 in which a detection state of an obstacle by the horizontal obstacle sensor 88 is displayed are illustrated.

In the tractor 1, the vehicle-mounted control unit 23 including the automatic travel control unit 23F or the like, the display device 50 of the mobile communication terminal 5, and the obstacle sensors 86 to 88 function as an obstacle detection system that detects obstacles existing in surroundings of the tractor 1, displays positions of the detected obstacles, and controls the travel of the tractor 1 in accordance with the detection positions of the obstacles.

The automatic travel control unit 23F performs travel direction determination processing in which a current travel direction of the tractor 1 is determined based on the position of the tractor 1 obtained by the positioning unit 30 and the travel direction of the tractor 1 included in the target path P. The automatic travel control unit 23F executes, based on determination results in the travel direction determination processing, the detection information of each of the obstacle sensors 86 to 88 transmitted to the vehicle-mounted control unit 23, or the like, obstacle display control in which display on the display device 50 of the mobile communication terminal 5 is controlled to indicate presence or absence of obstacles and locations of the obstacles, collision avoidance control in which travel of the tractor 1 is controlled to avoid collision with the obstacles, or the like.

In the obstacle display control, the automatic travel control unit 23F instructs the display control unit 51A of the mobile communication terminal 5 to execute each obstacle information display processing in accordance with the detection information of each of the obstacle sensors 86 to 88 to control display on the display device 50 of the mobile communication terminal 5.

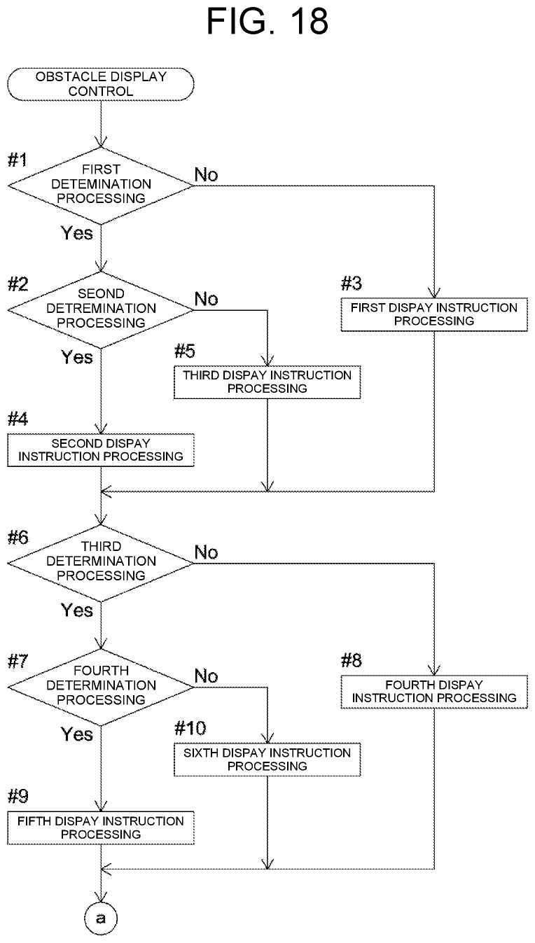

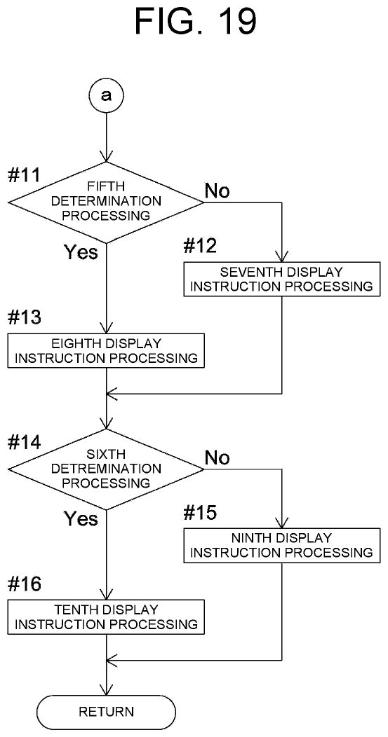

In the following, based on the detection ranges Rd1 to Rd4 of the obstacle sensors 86 to 88 illustrated in FIG. 4 and flowcharts illustrated in FIGS. 18 to 19, a control operation of the automatic travel control unit 23F in the obstacle display control will be described. In addition, based on the work screen 70 of the display device 50 illustrated in FIGS. 11 to 17, various types of obstacle information display processing executed by the display control unit 51A of the mobile communication terminal 5 in accordance with the control operation in accordance with the control operation of the automatic travel control unit 23F in the obstacle display control will be described.

Based on the detection information of the front obstacle sensor 86, the automatic travel control unit 23F performs first determination processing in which whether an obstacle has been detected in a forward travel speed control range including the deceleration control range Rdc and the stop control range Rsc of the first detection range Rd1 is determined (Step #1). If an obstacle has been detected in the first determination processing, the automatic travel control unit 23F performs second determination processing in which whether a detection position of the obstacle is in the deceleration control range Rdc of the forward travel speed control range is determined (Step #2).

If no obstacle has been detected in the first determination processing, the automatic travel control unit 23F performs first display instruction processing in which an instruction for execution of first obstacle information display processing is given to the display control unit 51A of the mobile communication terminal 5 (Step #3). In the first obstacle information display processing, the display control unit 51A of the mobile communication terminal 5 displays the first display area D1 of the obstacle information display unit 74 in a first reporting color (for example, green) that indicates that no obstacle has been detected in the forward travel speed control range (see FIG. 11 and FIGS. 14 to 17).

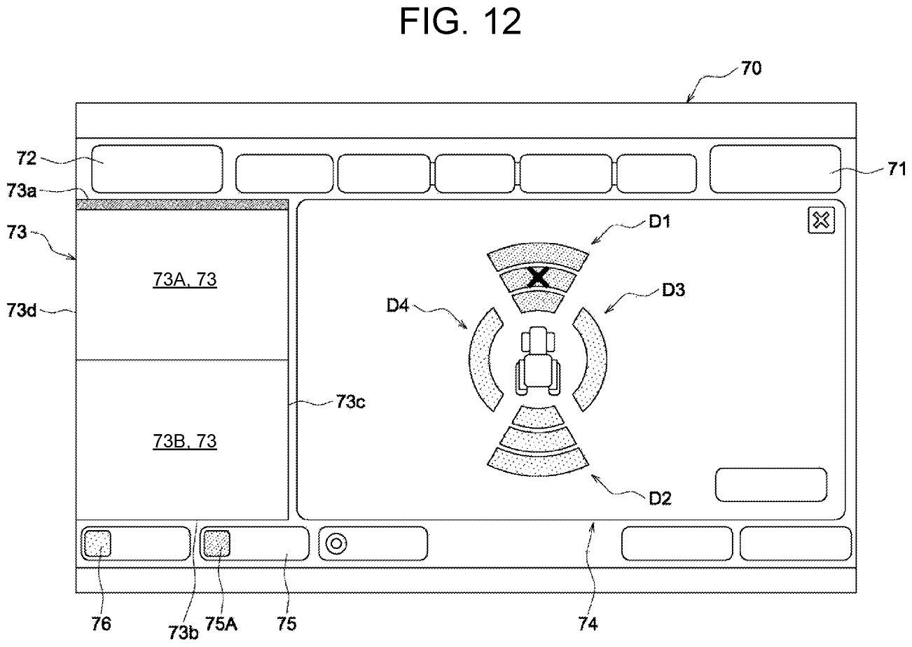

If the detection position of the obstacle is in the deceleration control range Rdc of the forward travel speed control range in the second determination processing, the automatic travel control unit 23F performs second display instruction processing in which an instruction for execution of second obstacle information display processing is given to the display control unit 51A of the mobile communication terminal 5 (Step #4). In the second obstacle information display processing, the display control unit 51A of the mobile communication terminal 5 displays the first display area D1 of the obstacle information display unit 74 in a second reporting color (for example, yellow) that indicates that an obstacle has been detected in the deceleration control range Rdc of the forward travel speed control range and displays a detection position of the obstacle in the first display area D1 by a × mark (see FIG. 12).

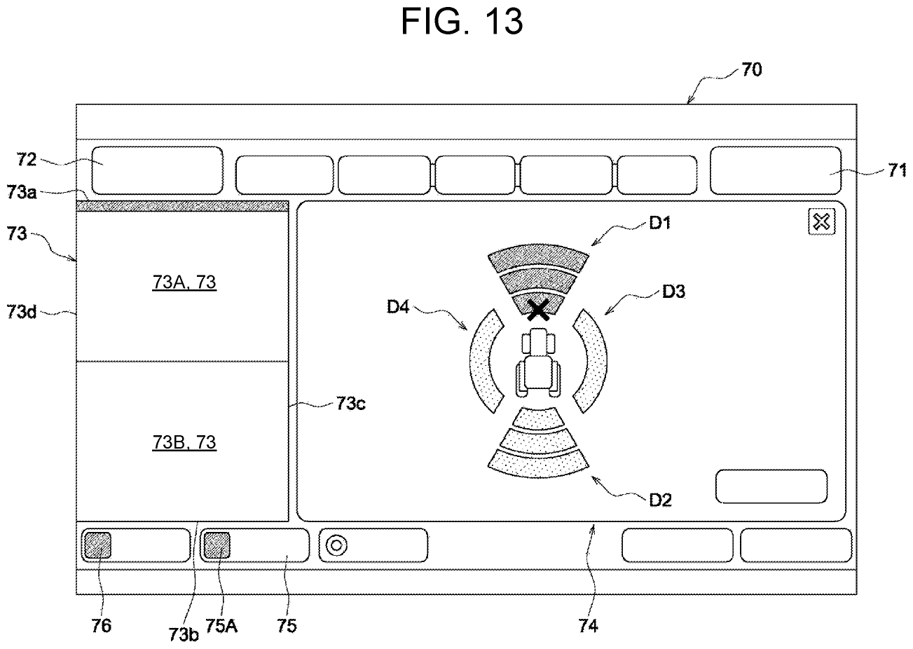

If the detection position of the obstacle is not in the deceleration control range Rdc of the forward travel speed control range in the second determination processing, the detection position of the obstacle is in the stop control range Rsc of the forward travel speed control range, and therefore, the automatic travel control unit 23F performs third display instruction processing in which an instruction for execution of third obstacle information display processing is given to the display control unit 51A of the mobile communication terminal 5 (Step #5). In the third obstacle information display processing, the display control unit 51A of the mobile communication terminal 5 displays the first display area D1 of the obstacle information display unit 74 in a third reporting color (for example, red) that indicates that an obstacle has been detected in the stop control range Rsc of the forward travel speed control range and displays a detection position of the obstacle in the first display area D1 by a × mark (see FIG. 13).

The automatic travel control unit 23F performs third determination processing in which whether an obstacle has been detected in the backward travel speed control range including the deceleration control range Rdc and the stop control range Rsc of the second detection range Rd2 is determined based on the detection information of the rear obstacle sensor 87 (Step #6). If an obstacle has been detected in the third determination processing, the automatic travel control unit 23F performs fourth determination processing in which whether a detection position of the obstacle is in the deceleration control range Rdc of the backward travel speed control range is determined (Step #7).

If no obstacle has been detected in the third determination processing, the automatic travel control unit 23F performs fourth display instruction processing in which an instruction for execution of fourth obstacle information display processing is given to the display control unit 51A of the mobile communication terminal 5 (Step #8). In the fourth obstacle information display processing, the display control unit 51A of the mobile communication terminal 5 displays the second display area D2 of the obstacle information display unit 74 in the first reporting color that indicates that no obstacle has been detected in the backward travel speed control range (see FIGS. 11 to 17).

If the detection position of the obstacle is in the deceleration control range Rdc of the backward travel speed control range in the fourth determination processing, the automatic travel control unit 23F performs fifth display instruction processing in which an instruction for execution of fifth obstacle information display processing is given to the display control unit 51A of the mobile communication terminal 5 (Step #9). In the fifth obstacle information display processing, the display control unit 51A of the mobile communication terminal 5 displays the second display area D2 of the obstacle information display unit 74 in the second reporting color that indicates that an obstacle has been detected in the deceleration control range Rdc of the backward travel speed control range and displays a detection position of the obstacle in the second display area D2 by a × mark.

If the detection position of the obstacle is not in the deceleration control range Rdc of the backward travel speed control range in the fourth determination processing, the detection position of the obstacle is in the stop control range Rsc of the backward travel speed control range, and therefore, the automatic travel control unit 23F performs sixth display instruction processing in which an instruction for execution of sixth obstacle information display processing is given to the display control unit 51A of the mobile communication terminal 5 (Step #10). In the sixth obstacle information display processing, the display control unit 51A of the mobile communication terminal 5 displays the second display area D2 of the obstacle information display unit 74 in the third reporting color that indicates that an obstacle has been detected in the stop control range Rsc of the backward travel speed control range and displays a detection position of the obstacle in the second display area D2 by a × mark.

The automatic travel control unit 23F performs fifth determination processing in which whether an obstacle has been detected in the third detection range Rd3 is determined, based on the detection information of the horizontal obstacle sensor 88 (Step #11).

If no obstacle has been detected in the fifth determination processing, the automatic travel control unit 23F performs seventh display instruction processing in which an instruction for execution of seventh obstacle information display processing is given to the display control unit 51A of the mobile communication terminal 5 (Step #12). In the seventh obstacle information display processing, the display control unit 51A of the mobile communication terminal 5 displays the third display area D3 of the obstacle information display unit 74 in the first reporting color that indicates that no obstacle has been detected in the third detection range Rd3 (See FIGS. 11 to 13 and FIGS. 15 to 17).

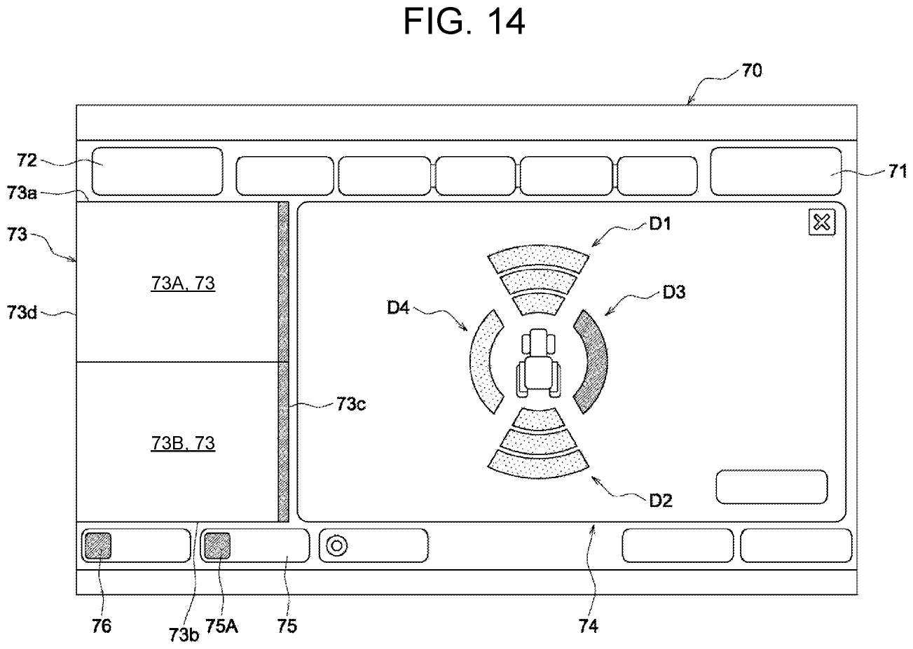

If an obstacle has been detected in the fifth determination processing, the automatic travel control unit 23F performs eighth display instruction processing in which an instruction for execution of eighth obstacle information display processing is given to the display control unit 51A of the mobile communication terminal 5 (Step #13). In the eighth obstacle information display processing, the display control unit 51A of the mobile communication terminal 5 displays the third display area D3 of the obstacle information display unit 74 in the third reporting color that indicates that an obstacle has been detected in the third detection range Rd3 (see FIG. 14).

The automatic travel control unit 23F performs sixth determination processing in which whether an obstacle has been detected in the fourth detection range Rd4 is determined based on the detection information of the horizontal obstacle sensor 88 (Step #14).

If no obstacle has been detected in the sixth determination processing, the automatic travel control unit 23F performs ninth display instruction processing in which an instruction for execution of ninth obstacle information display processing is given to the display control unit 51A of the mobile communication terminal 5 (Step #15). In the ninth obstacle information display processing, the display control unit 51A of the mobile communication terminal 5 displays the fourth display area D4 of the obstacle information display unit 74 in the first reporting color that indicates that no obstacle has been detected in the fourth detection range Rd4. (See FIGS. 11 to 17).

If an obstacle has been detected in the sixth determination processing, the automatic travel control unit 23F performs tenth display instruction processing in which an instruction for execution of tenth obstacle information display processing is given to the display control unit 51A of the mobile communication terminal 5 (Step #16). In the tenth obstacle information display processing, the display control unit 51A of the mobile communication terminal 5 displays the fourth display area D4 of the obstacle information display unit 74 in the third reporting color that indicates that an obstacle has been detected in the fourth detection range Rd4.

That is, if no obstacle has been detected in any one of the forward travel speed control range of the first detection range Rd1, the backward travel speed control range of the second detection range Rd2, the third detection range Rd3, and the fourth detection range Rd4, a display state of the obstacle information display unit 74 in the display device 50 of the mobile communication terminal 5 is controlled to an undetected display state. In addition, if an obstacle has been detected in any one of the forward travel speed control range of the first detection range Rd1, the backward travel speed control range of the second detection range Rd2, the third detection range Rd3, and the fourth detection range Rd4, when an obstacle is detected in the first detection range Rd1, the display state of the obstacle information display unit 74 is controlled to the detection display state in accordance with a position of the detected obstacle. Thus, the user can easily grasp the position of the detected obstacle by viewing the obstacle information display unit 74 and can confirm that each of the obstacle sensors 86 to 88 properly functions.

In the collision avoidance control, the automatic travel control unit 23F controls travel of the tractor 1 by instructing the shifting unit control unit 23B to execute travel control for each collision avoidance in accordance with the detection information of each of the obstacle sensors 86 to 88 or the like.

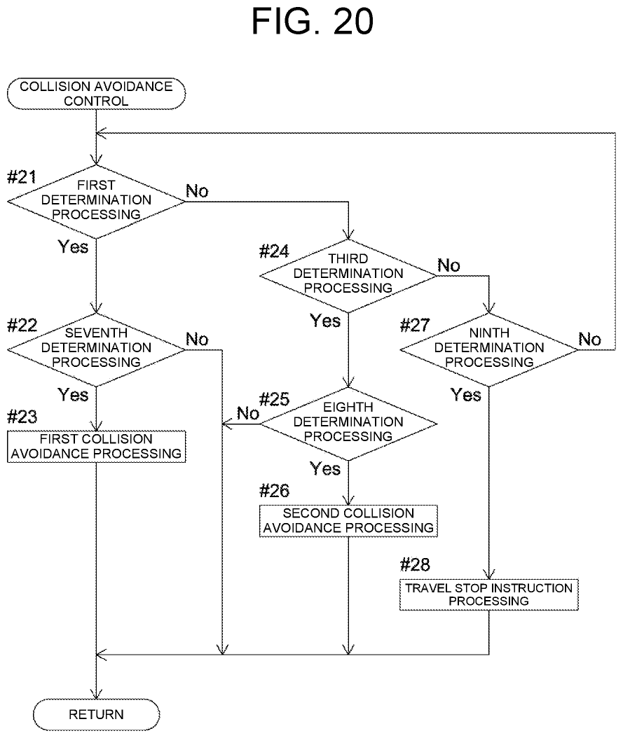

In the following, based on the detection ranges Rd1 to Rd4 of the obstacle sensors 86 to 88 illustrated in FIG. 4 and the flowcharts illustrated in FIGS. 20 to 22, a control operation of the automatic travel control unit 23F in the collision avoidance control will be described. In addition, travel control for each collision avoidance executed by the shifting unit control unit 23B in accordance with the control operation of the automatic travel control unit 23F in collision avoidance control will be described.

The automatic travel control unit 23F performs the first determination processing described above, based on the detection information of the front obstacle sensor 86 (Step #21). In the first determination processing of Step #21, if an obstacle has been detected in the forward travel speed control range, the automatic travel control unit 23F performs seventh determination processing in which whether the first detection range Rd1 of the front obstacle sensor 86 that is detecting obstacles corresponds to the travel direction of the tractor 1 is determined (Step #22). In the seventh determination processing, the automatic travel control unit 23F determines that the first detection range Rd1 of the front obstacle sensor 86 corresponds to the travel direction of the tractor 1 if the travel direction of the tractor 1 is the forward travel direction. In addition, if the direction of travel of the tractor 1 is the backward travel direction, the automatic travel control unit 23F determines that the first detection range Rd1 of the front obstacle sensor 86 does not correspond to the travel direction of the tractor 1.

In the seventh determination processing, the automatic travel control unit 23F performs the first collision avoidance processing if the first detection range Rd1 of the front obstacle sensor 86 corresponds to the travel direction of the tractor 1 (Step #23). If the first detection range Rd1 does not correspond to the travel direction of the tractor 1, control processing for collision avoidance in accordance with the detection information of the front obstacle sensor 86 is prevented from being performed in the shifting unit control unit 23B by ignoring the detection information of the front obstacle sensor 86.

If no obstacle has been detected in the first determination processing of Step #21, the automatic travel control unit 23F performs the third determination processing described above, based on the detection information of the rear obstacle sensor 87 (Step #24). Then, in the third determination processing of Step #24, if an obstacle has been detected in the backward travel speed control range, the automatic travel control unit 23F performs eighth determination processing in which whether the second detection range Rd2 of the rear obstacle sensor 87 that is detecting obstacles corresponds to the travel direction of the tractor 1 is determined based on determination results in the travel direction determination processing described above (Step #25).

In the eighth determination processing, the automatic travel control unit 23F determines that the second detection range Rd2 of the rear obstacle sensor 87 corresponds to the travel direction of the tractor 1 if the travel direction of the tractor 1 is the backward travel direction. If the travel direction of the tractor 1 is the forward travel direction, the automatic travel control unit 23F determines that the second detection range Rd2 of the rear obstacle sensor 87 does not correspond to the travel direction of the tractor 1.

In the eighth determination processing, the automatic travel control unit 23F performs second collision avoidance processing if the second detection range Rd2 of the rear obstacle sensor 87 corresponds to the travel direction of the tractor 1 (Step #26). If the second detection range Rd2 does not correspond to the travel direction of the tractor 1, control processing for collision avoidance in accordance with the detection information of the rear obstacle sensor 87 is prevented from being performed in the shifting unit control unit 23B by ignoring the detection information of the rear obstacle sensor 87.

If no obstacle has been detected in the third determination processing, the automatic travel control unit 23F performs ninth determination processing in which whether an obstacle has been detected in the third detection range Rd3 or the fourth detection range Rd4 is determined based on the detection information of the horizontal obstacle sensor 88 (Step #27).

In the ninth determination processing, the automatic travel control unit 23F performs travel stop instruction processing in which an instruction for execution of travel stop control for collision avoidance is given to the shifting unit control unit 23B if an obstacle has been detected in the ninth determination processing (Step #28). In the travel stop control for collision avoidance, the shifting unit control unit 23B stops travel of the tractor 1 such that the tractor 1 does not contact the obstacle located in the third detection range Rd3 and the fourth detection range Rd4 by performing a deceleration operation of the continuously variable transmission or the like.

If no obstacle has been detected in the ninth determination processing, the automatic travel control unit 23F returns to the first determination processing of Step #21.

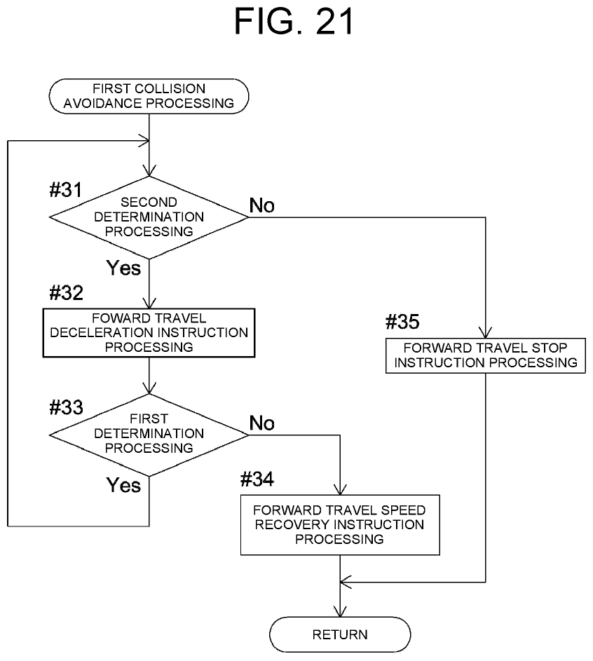

The automatic travel control unit 23F performs the second determination processing described above in the first collision avoidance processing (see FIG. 21) (Step #31). If the detection position of the obstacle is in the deceleration control range Rdc of the forward travel speed control range in the second determination processing of Step #31, the automatic travel control unit 23F performs forward travel deceleration instruction processing in which an instruction for execution of forward deceleration control for collision avoidance is given to the shifting unit control unit 23B (Step #32). In the forward travel deceleration control for collision avoidance, the shifting unit control unit 23B performs a deceleration operation of the continuously variable transmission to reduce forward travel speed of the tractor 1 as a distance to an obstacle located in the deceleration control range Rdc of the forward travel speed control range reduces.

The automatic travel control unit 23F performs the above-described first determination processing after performing the forward travel deceleration instruction processing (Step #33). In the first determination processing of Step #33, if an obstacle has been detected in the forward travel speed control range, the process returns to the second determination processing of Step #31.

In the first determination processing of Step #33, if no obstacle has been detected in the forward travel speed control range, the automatic travel control unit 23F performs forward travel speed recovery instruction processing in which an instruction for execution of forward travel speed recovery control is given to the shifting unit control unit 23B (Step #34). In the forward travel speed recovery control, the shifting unit control unit 23B increases the forward travel speed of the tractor 1 to target vehicle speed corresponding to a current position of the tractor 1 included in the target path P by performing an acceleration operation of the continuously variable transmission.

In the second determination processing of Step #31, if the detection position of the obstacle is not in the deceleration control range Rdc of the forward travel speed control range, the detection position of the obstacle is in the stop control range Rsc of the forward travel speed control range. Accordingly, the automatic travel control unit 23F performs forward travel stop instruction processing in which an instruction for execution of forward travel stop control for collision avoidance is given to the shifting unit control unit 23B (Step #35). In the forward travel stop control for collision avoidance, the shifting unit control unit 23B stops forward travel of the tractor 1 until tractor 1 contacts the obstacle located in the stop control range Rsc of the forward travel speed control range by performing a deceleration operation by the continuously variable transmission or the like.

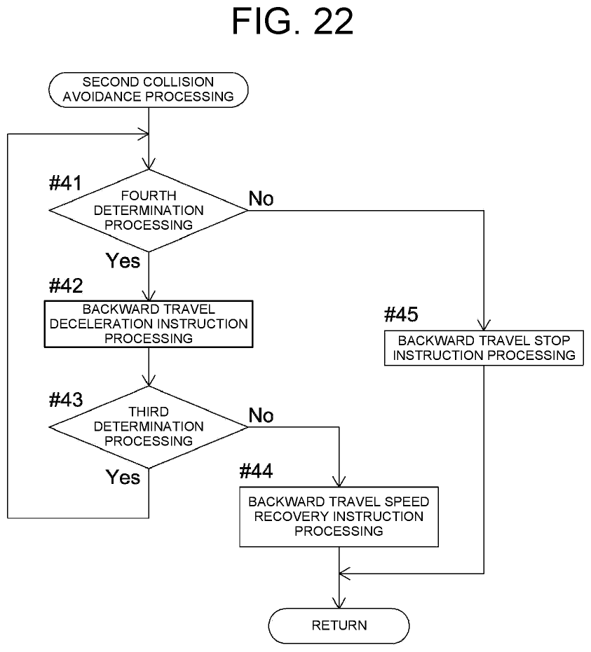

The automatic travel control unit 23F performs the fourth determination processing described above in the second collision avoidance processing (see FIG. 22) (Step #41). If the detection position of the obstacle is in the deceleration control range Rdc of the backward travel speed control range in the fourth determination processing of Step #41, the automatic travel control unit 23F performs backward travel deceleration instruction processing in which an instruction for execution of backward travel deceleration control for collision avoidance is given to the shifting unit control unit 23B (Step #42). In the backward travel deceleration control for collision avoidance, the shifting unit control unit 23B reduces backward travel speed of the tractor 1 as a distance to an obstacle located in the deceleration control range Rdc of the backward travel speed control range reduces by performing the deceleration operation of the continuously variable transmission.

The automatic travel control unit 23F performs the above-described third determination processing after performing the backward travel deceleration instruction processing (Step #43). If an obstacle has been detected in the backward travel speed control range in the third determination processing of Step #43, the process returns to the fourth determination processing of Step #41.

If no obstacle has been detected in the backward travel speed control range in the third determination processing of Step #43, the automatic travel control unit 23F performs backward travel speed recovery instruction processing in which an instruction for execution of backward travel speed recovery control is given to the shifting unit control unit 23B (Step #44). In the backward travel speed recovery control, the shifting unit control unit 23B increases backward travel speed of the tractor 1 to target speed corresponding to the current position of the tractor 1 included in the target path P by performing the acceleration operation of the continuously variable transmission.

If the detection position of the obstacle is not in the deceleration control range Rdc of the backward travel speed control range in the fourth determination processing of Step #41, the detection position of the obstacle is in the stop control range Rsc of the backward travel speed control range, and therefore, the automatic travel control unit 23F performs backward travel stop instruction processing in which an instruction for execution of backward travel stop control for collision avoidance is given to the shifting unit control unit 23B (Step #45). In the backward travel stop control for collision avoidance, the shifting unit control unit 23B stops backward travel of the tractor 1 until the tractor 1 contacts the obstacle located in the stop control range Rsc of the backward travel speed control range by performing the deceleration operation by the continuously variable transmission or the like.

That is, if an obstacle has been detected by the front obstacle sensor 86 or the rear obstacle sensor 87 whose detection range Rd1 or Rd2 corresponds to the travel direction of the tractor 1 in the forward travel speed control range or the backward travel speed control range thereof, or if an obstacle has been detected by the horizontal obstacle sensor 88 in the third detection range Rd3 or the fourth detection range Rd4, the automatic travel control unit 23F performs obstacle display control in which the position of the detected obstacle is displayed on the display device 50 of the mobile communication terminal 5. Furthermore, the automatic travel control unit 23F performs collision avoidance control in which travel of the tractor 1 is controlled.

On the other hand, if an obstacle has been detected by the front obstacle sensor 86 or the rear obstacle sensor 87 whose detection range Rd1 or Rd2 does not correspond to the travel direction of the tractor 1, the automatic travel control unit 23F performs obstacle display control without performing collision avoidance control based on the detection information of the front obstacle sensor 86 or the rear obstacle sensor 87.

As described above, if an obstacle has been detected by any one of the obstacle sensors 86 to 88 for which the travel direction or the left-right direction of the tractor 1 is set as any one of the detection ranges Rd1 to Rd4, the automatic travel control unit 23F instructs, based on the detection information of the corresponding one of the obstacle sensors 86 to 88 that has detected the obstacle, the shifting unit control unit 23B to execute travel control for collision avoidance in accordance with the detection information and controls travel of the tractor 1, and thus, it is possible to avoid a risk that the tractor 1 collides with the obstacle existing in the travel direction or the left-right direction of the tractor 1.

If an obstacle has been detected by the front obstacle sensor 86 or the rear obstacle sensor 87 for which an opposite direction that does not correspond to the travel direction of the tractor 1 is set as any one of the detection ranges Rd1 and Rd2, the automatic travel control unit 23F does not instruct the shifting unit control unit 23B to execute travel control for collision avoidance, and thus, reduction in work efficiency caused by execution of the travel control for collision avoidance for an obstacle with which the tractor 1 is not likely to collide can be avoided.

If an obstacle has been detected by any one of the obstacle sensors 86 to 88, the automatic travel control unit 23F instructs, based on the detection information of the corresponding one of the obstacle sensors 86 to 88 that has detected the obstacle, the display control unit 51A of the mobile communication terminal 5 to execute the obstacle information display processing in accordance with the detection information to display the detection position of the obstacle on the display device 50 of the mobile communication terminal 5, and thus, the user can grasp the position of the detected obstacle and can confirm that each of the obstacle sensors 86 to 88 normally functions.

If travel of the tractor 1 is stopped based on the above-described collision avoidance control, the display control unit 51A of the mobile communication terminal 5 displays a message that indicates that travel of the tractor 1 is stopped by collision avoidance control on the display device 50 of the mobile communication terminal 5.

As illustrated in FIGS. 11 to 17, if travel of the tractor 1 is stopped based on the above-described collision avoidance control, a notification unit 76 that indicates stop of travel of the tractor 1 based on the collision avoidance control is displayed on the work screen 70 displayed on the display device 50 of the mobile communication terminal 5. If stop of travel of the tractor 1 based on the collision avoidance control has been detected, the display control unit 51A of the mobile communication terminal 5 switches a display state of the notification unit 76 from a normal non-notification display state (for example, a state where the notification unit 76 is displayed in green: see FIGS. 11 to 12 and FIGS. 15 to 17) to a notification display state that indicates stop of travel of the tractor 1 based on the collision avoidance control (for example, a state where the notification unit 76 is displayed in red: see FIGS. 13 to 14).

Thus, if travel of the tractor 1 has been stopped, the user can easily grasp whether the stop of the travel of the tractor 1 is based on collision avoidance control by viewing the notification unit 76.

The rear obstacle sensor 87 is set to detect, in a case where there is a trailing work vehicle (not illustrated) that follows the tractor 1 when the tractor 1 travels forward, the trailing work vehicle as an obstacle when the trailing vehicle enters the backward travel speed control range.

Thus, during an accompanying work in which the trailing work vehicle exists, for example, when the trailing work vehicle is caused to travel with a certain distance from the preceding tractor 1 within the backward travel speed control range of the rear obstacle sensor 87, the automatic travel control unit 23F instructs, based on the detection information of the rear obstacle sensor 87 at this time, the display control unit 51A of the mobile communication terminal 5 to execute display switching processing in accordance with the detection information and displays a detection position of the trailing work vehicle on the display device 50 of the mobile communication terminal 5.

As a result, the user can grasp the position of the trailing work vehicle in relation to the tractor 1, and also, the user can confirm that the rear obstacle sensor 87 properly functions.

The second detection range Rd2 of the rear obstacle sensor 87 at this time does not correspond to the travel direction of the tractor 1, and thus, the automatic travel control unit 23F does not instruct the shifting unit control unit 23B to execute the travel control for collision avoidance, based on the detection information of the rear obstacle sensor 87 at this time. As a result, reduction in work efficiency caused by execution of travel control for collision avoidance for the trailing work vehicle or the like can be avoided.

Although not illustrated in the drawings, in a case where the trailing work vehicle is, for example, a work vehicle driven by the user on board, a boarding unit of the trailing work vehicle includes an installation unit that enables installation of the mobile communication terminal 5 in an appropriate position that facilitates viewing of the mobile communication terminal 5 by the user during driving.

Also in a case where travel of the tractor 1 is stopped on the target path P, the automatic travel control unit 23F obtains the travel direction of the tractor 1 set at a travel stop position of the tractor 1 on the target path P by performing the travel direction determination processing described above. The automatic travel control unit 23F performs, based on the obtained travel direction of the tractor 1 and the detection information of each of the obstacle sensors 86 to 88, a condition satisfaction determination processing in which whether a condition related to an obstacle used for permitting automatic travel of the tractor 1 is satisfied is determined.

To describe the condition satisfaction determination processing, if an obstacle has been detected in any one of the forward travel speed control range of the first detection range Rd1, the backward travel speed control range of the second detection range Rd2, the third detection range Rd3, and the fourth detection range Rd4 corresponding to the travel direction of the tractor 1, the automatic travel control unit 23F determines that a condition under which automatic travel of the tractor 1 is permitted is not satisfied and prohibits automatic travel of the tractor 1.

If no obstacle has been detected in any one of the forward travel speed control range, the backward travel speed control range, the third detection range Rd3, and the fourth detection range Rd4, or if an obstacle has been detected only in the forward travel speed control range or the backward travel speed control range that does not correspond to the travel direction of the tractor 1, the automatic travel control unit 23F determines that the condition under which automatic travel of the tractor 1 is permitted is satisfied and permits automatic travel of the tractor 1.

Thus, at a time of start of automatic travel of the tractor 1, a risk that the tractor 1 collides with an obstacle existing in the travel direction or in the left-right direction of the tractor 1 can be avoided while avoiding reduction in work efficiency due to prohibition of start of automatic travel based on an obstacle with which the tractor 1 is not likely to collide because the obstacle is located in the opposite direction to the travel direction of the tractor 1 then.

The automatic travel control unit 23F enables display of the presence or absence, a position, or the like of an obstacle on the display device 50 of the mobile communication terminal 5 by performing the above-described obstacle display control even in a case where travel of the tractor 1 is stopped on the target path P.

Thus, in a case where travel of the tractor 1 is stopped on the target path P, when the display device 50 of the mobile communication terminal 5 is operated to display the presence or absence, the position, or the like of an obstacle on the display device 50, whether each of the obstacle sensors 86 to 88 properly functions can be easily confirmed.

The automatic travel control unit 23F determines adhesion of dirt or the like to the sensor surface of the front obstacle sensor 86 or the rear obstacle sensor 87 and executes dirt handling travel control in which travel of the tractor 1 is controlled in accordance with an adhesion determination status of dirt or the like.

The automatic travel control unit 23F controls travel of the tractor 1 by instructing the shifting unit control unit 23B to execute each travel control in accordance with the adhesion determination status for dirt or the like in the dirt handling travel control.

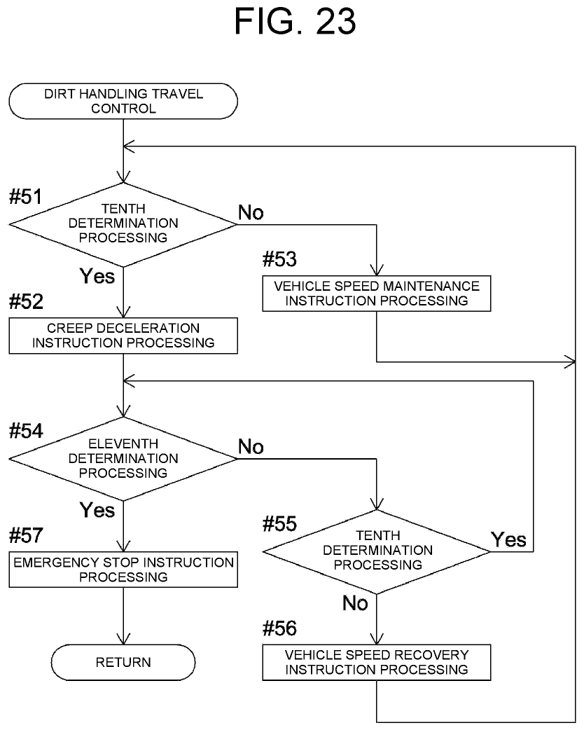

In the following, based on a flowchart illustrated in FIG. 23, a control operation of the automatic travel control unit 23F in the dirt handling travel control will be described and each travel control executed by the shifting unit control unit 23B in accordance with the control operation of the automatic travel control unit 23F in the dirt handling travel control.

Herein, a case where adhesion of dirt or the like to the sensor surface of the front obstacle sensor 86 is determined will be described as an example.

The automatic travel control unit 23F performs tenth determination processing in which whether a ratio of invalid values caused by measurement impediments, such as dirt, a floating object, or the like, included in the measurement information of the front obstacle sensor 86 for the first measurement range Rm1 of the front obstacle sensor 86 is a predetermined value (for example, 50%) or more is determined (Step #51).

If the ratio of invalid values is a predetermined value or more in the tenth determination processing, the automatic travel control unit 23F performs creep deceleration instruction processing in which an instruction for execution of creep deceleration control is given to the shifting unit control unit 23B (Step #52). The shifting unit control unit 23B reduces the vehicle speed of the tractor 1 to very low speed for creep travel in the creep deceleration control.

If the ratio of invalid values is not the predetermined value or more in the tenth determination processing, the automatic travel control unit 23F performs vehicle speed maintenance instruction processing in which an instruction for execution of vehicle speed maintenance control is given to the shifting unit control unit 23B (Step #53). In the vehicle speed maintenance control, the shifting unit control unit 23B maintains the vehicle speed of the tractor 1 at current set speed (set speed corresponding to the current position of the tractor 1 included in the target path P).

After the creep deceleration instruction processing is performed, the automatic travel control unit 23F performs eleventh determination processing in which whether a travel state at very low speed for creep travel has been continued for a predetermined time is determined and also performs the tenth determination processing described above until the predetermined time elapses (steps #54 to #55).

If the ratio of invalid values has been reduced to a ratio less than the predetermined value in the tenth determination processing of Step #55, the automatic travel control unit 23F determines that dirt or the like does adhere to the sensor surface of the front obstacle sensor 86 but a floating object, such as dust, fog, or the like floats around the front obstacle sensor 86 and performs the vehicle speed recovery instruction processing in which an instruction for execution of the vehicle speed recovery control is given to the shifting unit control unit 23B (Step #56), and then, the process returns to the tenth determination processing of Step #51. In the vehicle speed recovery control, the shifting unit control unit 23B causes the vehicle speed of the tractor 1 to recover to the set vehicle speed corresponding to the current position of the tractor 1 included in the target path P.

If the travel state at very low vehicle speed for creep travel has continued for the predetermined time in the eleventh determination processing, the automatic travel control unit 23F determines that dirt or the like adheres to the sensor surface of the front obstacle sensor 86 and performs emergency stop instruction processing in which an instruction for execution of travel stop control for dirt measures is given to the shifting unit control unit 23B (Step #57). The shifting unit control unit 23B immediately stops travel of the tractor 1 in the travel stop control for dirt measures.

Thus, if the ratio of invalid values to the first measurement range Rm1 of the front obstacle sensor 86 becomes the predetermined value or more while the tractor 1 automatically travels, the vehicle speed of the tractor 1 has been reduced to very low speed for creep travel and the tractor 1 is maintained in a travel state at very low speed, and therefore, an increased time can be set for determining whether a cause for the invalid values is an adhesive object, such as dirt or the like, on the sensor surface of the front obstacle sensor 86 or the rear obstacle sensor 87 or a floating object, such as dust, dirt, or the like, floating around the front obstacle sensor 86 or the rear obstacle sensor 87, as compared to a case where the tractor 1 is caused to travel at low speed.

By setting an increased time for determination in the above-described manner, it becomes easier to determine whether the cause for the invalid values is the adhesive object or the floating object, and thus, in a case where the cause for the invalid values is the floating object, reduction in work efficiency caused by stop of travel of the tractor 1 based on the floating object can be suppressed. Moreover, during determining whether the cause for the invalid values is the adhesive object or the floating object, occurrence of an inconvenience that the tractor collides with an obstacle can be suppressed.

As illustrated in FIGS. 11 to 17, the obstacle information display button 75 on the display device 50 in the mobile communication terminal 5 includes a detection status display unit 75A that displays a detection status of each of the obstacle sensors 86 to 88. The automatic travel control unit 23F executes detection status display control in which the detection status of each of the obstacle sensors 86 to 88 is indicated by controlling display in the detection status display unit 75A, based on the detection information of each of the obstacle sensors 86 to 88 or the like.

In the detection status display control, the automatic travel control unit 23F controls display of the detection status display unit 75A on the display device 50 of the mobile communication terminal 5 by instructing the display control unit 51A of the mobile communication terminal 5 to execute each detection status display processing in accordance with the detection status of each of the obstacle sensors 86 to 88.

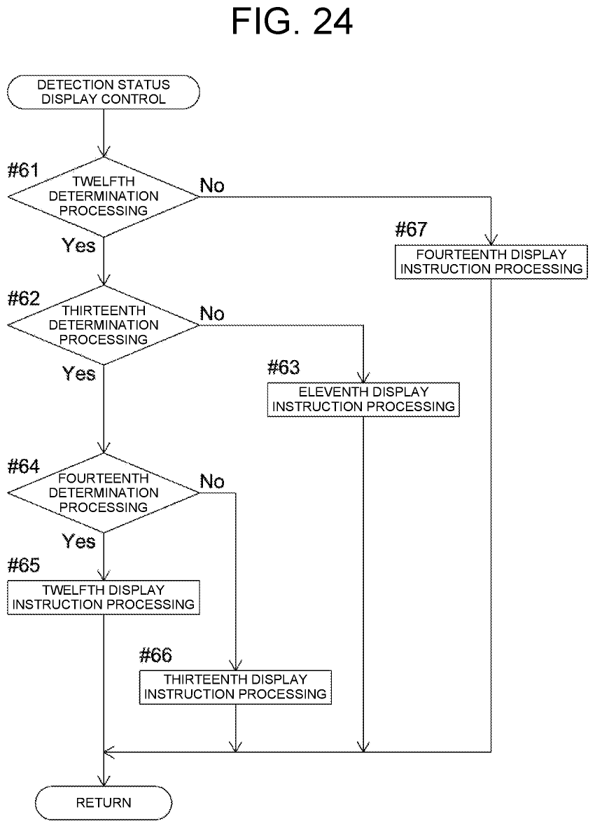

In the following, based on the detection ranges Rd1 to Rd4 of the obstacle sensors 86 to 88 illustrated in FIG. 4 and a flowchart illustrated in FIG. 24, the control operation of the automatic travel control unit 23F in the detection status display control will be described. In addition, based on the work screen 70 of the display device 50 illustrated in FIGS. 11 to 17, various types of detection status display processing executed by the display control unit 51A of the mobile communication terminal 5 in accordance with the control operation of the automatic travel control unit 23F in the detection status display control will be described.

The automatic travel control unit 23F performs twelfth determination processing in which whether an abnormality caused by adhesion of dirt or the like has occurred on the sensor surface of the front obstacle sensor 86 or the rear obstacle sensor 87, based on results of dirt determination in the above-described dirt handling travel control (Step #61). If no abnormality has occurred in the twelfth determination processing, the automatic travel control unit 23F performs thirteenth determination processing in which whether an obstacle has been detected in any one of the forward travel speed control range, the backward travel speed control range, the third detection range Rd3, and the fourth detection range Rd4 is determined based on the detection information of each of the obstacle sensors 86 to 88 (Step #62).

If no obstacle has been detected in the thirteenth determination processing, the automatic travel control unit 23F performs eleventh display instruction processing in which an instruction for execution of first determination status display processing is given to the display control unit 51A of the mobile communication terminal 5 (Step #63). In the first detection status display processing, the display control unit 51A of the mobile communication terminal 5 displays the detection status display unit 75A in the first reporting color (for example, green) that indicates a status in which no obstacle has been detected in any one of the forward travel speed control range, the backward travel speed control range, the third detection range Rd3, and the fourth detection range Rd4 (see FIG. 11).

If an obstacle has been detected in the thirteenth determination processing, the automatic travel control unit 23F performs fourteenth determination processing in which whether the detection position of the obstacle is in the deceleration control range Rdc of the forward travel speed control range or the backward travel speed control range is determined (Step #64).

If the detection position of the obstacle is in the deceleration control range Rdc of the forward travel speed control range or the backward travel speed control range in the fourteenth determination processing, the automatic travel control unit 23F performs twelfth display instruction processing in which an instruction for execution of second detection status display processing is given to the display control unit 51A of the mobile communication terminal 5 (Step #65). In the second detection status display processing, the display control unit 51A of the mobile communication terminal 5 displays the detection status display unit 75A in the second reporting color (for example, yellow) that indicates a status in which the obstacle has been detected in the deceleration control range Rdc of the forward travel speed control range or the backward travel speed control range (see FIG. 12).

If the detection position of the obstacle is not in the deceleration control range Rdc of the forward travel speed control range or the backward travel speed control range in the fourteenth determination processing, the detection position of the obstacle is in the stop control range Rsc of the forward travel speed control range or the backward travel speed control range, or in the third detection range Rd3 or the fourth detection range Rd4, the automatic travel control unit 23F performs thirteenth display instruction processing in which an instruction for execution of the third detection status display processing is given to the display control unit 51A of the mobile communication terminal 5 (Step #66). In the third detection status display processing, the display control unit 51A of the mobile communication terminal 5 displays the detection status display unit 75A in the third reporting color (for example, red) that indicates a status in which the obstacle has been detected in the stop control range Rsc of the forward travel speed control range or the backward travel speed control range, or in the third detection range Rd3 or the fourth detection range Rd4 (see FIGS. 13 to 14).

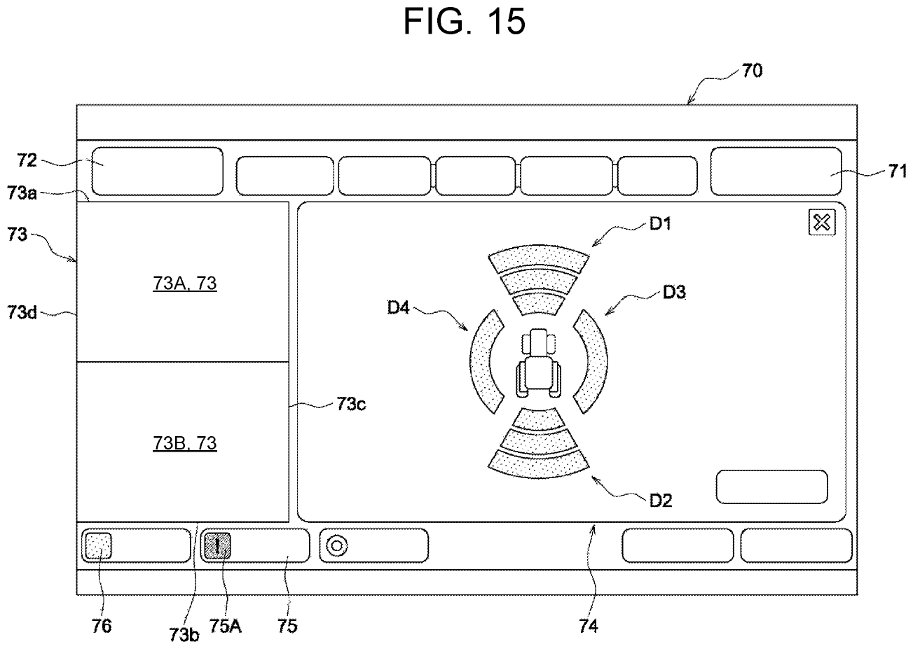

If an abnormality caused by adhesion of dirt or the like has occurred on the sensor surface in the twelfth determination processing, the automatic travel control unit 23F performs fourteenth display instruction processing in which an instruction for execution of fourth detection status display processing is given to the display control unit 51A of the mobile communication terminal 5 (Step #67). In the fourth detection status display processing, the display control unit 51A of the mobile communication terminal 5 displays the detection status display unit 75A in an abnormality reporting state (for example, a state where an exclamation mark is added to a display color of red) that indicates a status in which the abnormality caused by adhesion of dirt or the like has occurred on the sensor surface of the front obstacle sensor 86 or the rear obstacle sensor 87 (see FIG. 15).

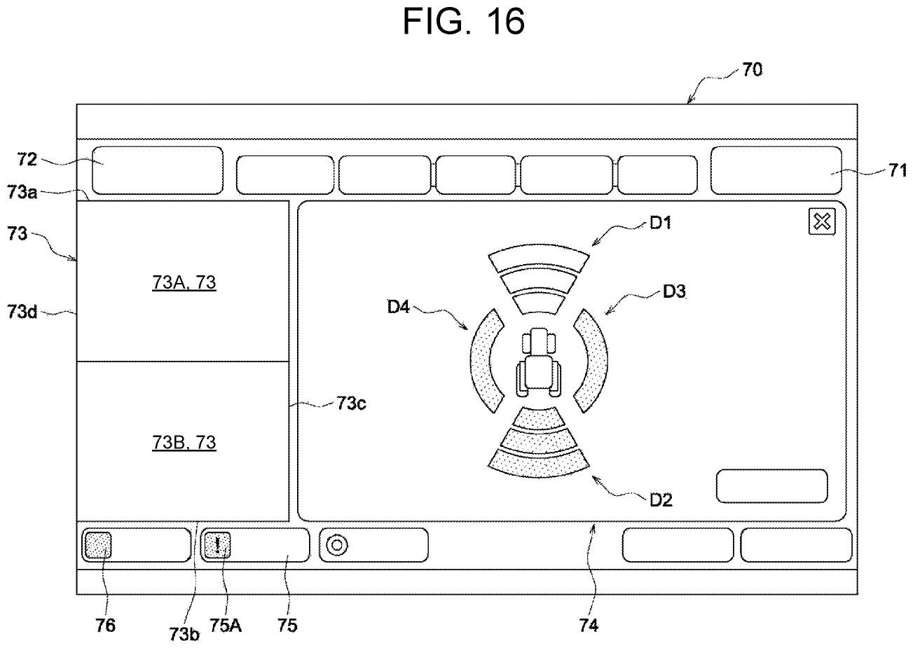

The display control unit 51A of the mobile communication terminal 5 displays, as illustrated in FIG. 16, the detection status display unit 75A of the display device 50 in a detection prohibition state (for example, a state where an exclamation mark is added to a display color of yellow) that indicates a status in which any one of the detection ranges Rd1 to Rd4 is set as an obstacle detection prohibition range in a case where any one of the detection ranges Rd1 to Rd4 for detection by each of the obstacle sensors 86 to 88 is set as an obstacle detection prohibition range by an operation of the display device 50, and displays any one of the display areas D1 to D4 (the first display area D1 in FIG. 16) corresponding to the detection ranges Rd1 to Rd4 set as the detection prohibition range in the obstacle information display unit 74 of the display device 50 in a detection prohibition color (for example, gray) that indicates that any one of the display areas D1 to D4 has been set as the obstacle detection prohibition range.

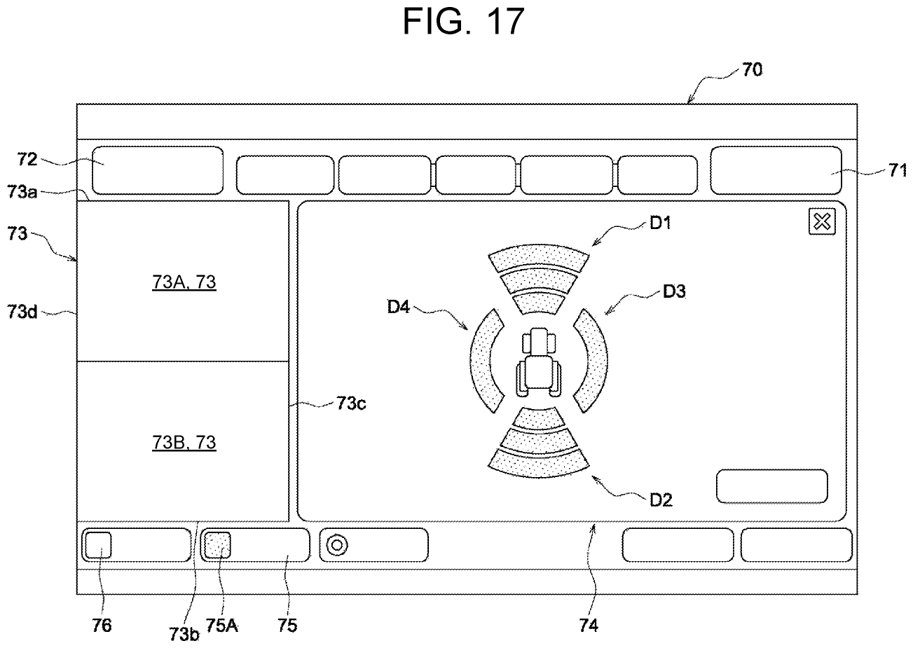

The display control unit 51A of the mobile communication terminal 5 displays the detection status display unit 75A of the obstacle information display button 75 on the display device 50 in the fourth reporting color (for example, gray) that indicates a status in which the detection information of each of the obstacle sensors 86 to 88 cannot be properly received, as illustrated in FIG. 17, in a case where the detection information of each of the obstacle sensors 86 to 88 cannot be received due to a CAN communication failure, a communication failure with the vehicle-mounted control unit 23, or the like in the tractor 1.

As described above, in the display device 50 of the mobile communication terminal 5, display of the detection status display unit 75A of the obstacle information display button 75 is controlled in accordance with the detection status of each of the obstacle sensors 86 to 88, and thus, the user can easily grasp the detection status of each of the obstacle sensors 86 to 88 by viewing the detection status display unit 75A.

As illustrated in FIGS. 11 to 17, the image display unit 73 displayed on the display device 50 of the mobile communication terminal 5 is divided into a front image display area 73A in which a front side image of the tractor 1 from the imaging unit 80 is displayed and a rear image display area 73B in which a rear side image thereof is displayed in an up and down direction. The image display unit 73 is set up for display such that each of upper, lower, left, and right edge portions 73a to 73c functions as a detection direction display unit that indicates a detection direction of an obstacle.

If detection of an obstacle in the deceleration control range Rdc or the stop control range Rsc of the first detection range Rd1 by the front obstacle sensor 86 has been detected through communication with the vehicle-mounted control unit 23 (an instruction from the automatic travel control unit 23F), the display control unit 51A of the mobile communication terminal 5 displays the upper edge 73a of the image display unit 73 in a detection reporting color (for example, red) that indicates the detection of the obstacle (see FIG. 12).

If detection of an obstacle in the deceleration control range Rdc or the stop control range Rsc of the second detection range Rd2 by the rear obstacle sensor 87 has been detected, the display control unit 51A of the mobile communication terminal 5 displays the lower edge 73b of the image display unit 73 in a detection reporting color that indicates the detection of the obstacle.

If detection of an obstacle in the third detection range Rd3 by the horizontal obstacle sensor 88 has been detected, the display control unit 51A of the mobile communication terminal 5 displays the right edge portion 73c of the image display unit 73 in a detection reporting color that indicates the detection of the obstacle (see FIG. 14).

If detection of an obstacle in the fourth detection range Rd4 by the horizontal obstacle sensor 88 has been detected, the display control unit 51A of the mobile communication terminal 5 displays the left edge portion 73d of the image display unit 73 in a detection reporting color that indicates the detection of the obstacle.

Thus, even in a state where the user views the front side image or the rear side image of the tractor 1 displayed on the image display unit 73 of the display device 50 in the mobile communication terminal 5, if an obstacle has been detected by any one of the obstacle sensors 86 to 88, the user can easily grasp a detection direction of an obstacle with respect to the tractor 1.

### Other Embodiments

Other embodiments of the present invention will be described. Note that a configuration of each of the other embodiments described below can be not only applied independently but also applied in combination with a configuration of another embodiment.

(1) A configuration of a work vehicle 1 can be changed in various manners.

For example, the work vehicle 1 may be configured in a semi-crawler specification including left and right crawlers instead of the left and right rear wheels 11.

For example, the work vehicle 1 may be configured in a full crawler specification including left and right crawlers instead of left and right front wheels 10 and left and right rear wheels 11.

For example, the work vehicle 1 may be configured in an electric specification including an electric motor instead of the engine 14.

For example, the work vehicle 1 may be configured in a hybrid specification including the engine 14 and an electric motor.

For example, the work vehicle 1 may be configured such that only manual travel is possible and moreover travel control of the work vehicle 1 by the control unit 23 in accordance with a detection position of an obstacle by the front obstacle sensor 86 or the rear obstacle sensor 87 is possible.

(2) The obstacle detection system may include, in addition to the front obstacle sensor 86 and the rear obstacle sensor 87, a right LIDAR sensor for which the right side of the work vehicle 1 is set as an obstacle detection range Rd1 and a left LIDAR sensor for which the left side of the work vehicle 1 is set as the obstacle detection range Rd1 as the horizontal obstacle sensors 88. Moreover, the obstacle detection system may further include the front obstacle sensor 86 and the rear obstacle sensor 87 without the horizontal obstacle sensor 88.

(3) The display device provided in the operation terminal 27 of the drive unit 12 may be configured to function as a display unit that displays positions of obstacles detected by the front obstacle sensor 86 and the rear obstacle sensor 87, similar to the display device 50 of the mobile communication terminal (a wireless communication device) 5.

(4) The control unit 23 (the automatic travel control unit 23F) may be configured to determine the travel direction of the work vehicle 1, based on detection information from a reverser sensor 22B that detects an operation position of a reverser lever for switching forward travel and backward travel or a sensor that detects a transmission state of a forward travel and backward travel switching device.

(5) The control unit 23 (the automatic travel control unit 23F) may be configured to perform travel control in which the front wheels 10 are steered to bypass an obstacle, as travel control of the work vehicle 1 in accordance with a detection position of the obstacle.

(6) The control unit 23 (the automatic travel control unit 23F) may be configured to, in the first determination processing and the third determination processing of the obstacle display control, instead of determining whether an obstacle has been detected in the front travel speed control range including the deceleration control range Rdc and the stop control range Rsc of the first detection range Rd1 or the second detection range Rd2, determine whether an obstacle has been detected in the first detection range Rd1 or the second detection range Rd2 and, in the second determination processing and the fourth determination processing of the obstacle display control, instead of determining whether a detection position of an obstacle is in the deceleration control range Rdc of the forward travel speed control range, determine whether a detection position of an obstacle is in any one of the notification control range Rnc, the deceleration control range Rdc, and the stop control range Rsc of the first detection range Rd1 and the second detection range Rd2.

In this configuration, presumably, if an obstacle has been detected in the notification control range Rnc of either one of the front and rear obstacle sensors 86 and 87 whose obstacle detection range Rd1 or Rd2 corresponds to the travel direction of the work vehicle 1, an alarm buzzer provided in the work vehicle 1 or the wireless communication device 5 is operated to inform that there is an obstacle in the travel direction of the work vehicle 1 and, if an obstacle has been detected in the notification control range Rnc of either one of the front and rear obstacle sensors 86 and 87 whose obstacle detection range Rd1 or Rd2 does not correspond to the travel direction of the work vehicle 1, the alarm buzzer is not operated so that a probability that unpleasant feeling is given to the user by an unnecessary operation of the alarm buzzer in accordance with detection of an obstacle with which the work vehicle 1 is not likely to collide because the obstacle exists in an opposite direction to the travel direction of the work vehicle 1 can be avoided.

(7) Learning processing for recognizing a person, such as a worker working in the field A or the like, some other work vehicle, such as a trailing work vehicle or the like, a pole, a tree, or the like existing in the field A, or the like as an obstacle may be performed on the imaging unit 80, a front camera 81 may be provided in the front obstacle sensor 86, and a rear camera 82 may be included in the rear obstacle sensor 87. In this case, based on measurement information from the front and rear LIDAR sensors having high distance measurement accuracy and information from the imaging unit 80 having high object discrimination accuracy, detection of an obstacle can be performed with higher accuracy.

### ADDENDUM OF THE INVENTION

A second feature configuration of the present invention is that the control unit is included in an automatic travel unit that enables automatic travel of the work vehicle, and the display unit is included in a wireless communication device set up for communication so as to be wirelessly communicable with the automatic travel unit.

According to this configuration, if there is an obstacle in a travel direction of the work vehicle that automatically travels, an obstacle is detected by either one of front and rear obstacle sensors whose detection range corresponds to the travel direction of the work vehicle and a detection position of the obstacle detected by the one of the front and rear obstacle sensors is displayed on the display unit of the wireless communication device. If there is an obstacle in the opposite direction of the automatic work vehicle, the obstacle is detected by either one of the front or rear obstacle sensors whose detection range does not correspond to the travel direction of the work vehicle, and the detection position of the obstacle by either the front or rear obstacle sensor is displayed on the display unit of the wireless communication device.

As a result, while enabling automatic travel of the work vehicle, the user who monitors the automatic travel of the work vehicle can easily confirm that the front and rear obstacle sensors properly function.

A third feature configuration of the present invention is that if there is a trailing work vehicle that follows the work vehicle while the work vehicle is traveling forward, the rear obstacle sensor detects the trailing work vehicle as the obstacle when the trailing work vehicle enters the detection range of the rear obstacle sensor.

According to this configuration, during an accompanying work in which there is a trailing work vehicle, for example, when the trailing work vehicle is caused to travel with a certain distance from the preceding work vehicle within the detection range of the rear obstacle sensor, the detection position of the trailing work vehicle detected by the rear obstacle sensor at this time is displayed on the display unit.

Since the detection range of the rear obstacle sensor at this time does not correspond to the travel direction of the work vehicle, the collision avoidance control in accordance with the detection position of the trailing work vehicle is not executed based on the detection information of the rear obstacle sensor at this time.

As a result, the user who monitors travel of the work vehicle and the trailing work vehicle can easily grasp the position of the trailing work vehicle in relation to the work vehicle and can easily confirm that the rear obstacle sensor properly functions while avoiding reduction in work efficiency caused by execution of collision avoidance control in accordance with the detection position of the trailing work vehicle or the like.

1. An obstacle detection system comprising:
a front obstacle sensor for which a front side of a work vehicle is set as an obstacle detection range;
a rear obstacle sensor for which a rear side of the work vehicle is set as the obstacle detection range;
a display unit that displays a position of the obstacle detected by the front obstacle sensor and the rear obstacle sensor; and
a control unit that determines a travel direction of the work vehicle and performs control related to the obstacle including display by the display unit, based on results of the determination and detection information of the front obstacle sensor and the rear obstacle sensor,
wherein if the obstacle has been detected by the front obstacle sensor or the rear obstacle sensor whose detection range corresponds to the travel direction of the work vehicle, the control unit displays a detection position of the obstacle on the display unit and executes collision avoidance control in accordance with the detection position of the obstacle, and
if the obstacle has been detected by the front obstacle sensor or the rear obstacle sensor whose detection range does not correspond to the travel direction of the work vehicle, the control unit displays a detection position of the obstacle on the display unit without executing the collision avoidance control.

2. The obstacle detection system according to claim 1,
wherein the control unit is included in an automatic travel unit that enables automatic travel of the work vehicle, and
the display unit is provided in a wireless communication device set up for communication so as to be wirelessly communicable with the automatic travel unit.

3. The obstacle detection system according to claim 1,
wherein if there is a trailing work vehicle that follows the work vehicle while the work vehicle travels forward, the rear obstacle sensor detects the trailing work vehicle as the obstacle when the trailing work vehicle enters the detection range of the rear obstacle sensor.
